(19) United States
(12) Patent Application Publication
(10) Pub. No.: US 2024/0031891 A1
(43) Pub. Date: Jan. 25, 2024

(54) FORWARD HANDOVER PROCEDURES FOR L2 RELAY MOBILITY

(71) Applicant: QUALCOMM Incorporated, San Diego, CA (US)

(72) Inventors: Peng CHENG, Beijing (CN); Karthika PALADUGU, Hyderabad (IN); Hong CHENG, Basking Ridge, NJ (US); Ozcan OZTURK, San Diego, CA (US); Gavin Bernard HORN, La Jolla, CA (US)

(21) Appl. No.: 18/254,149

(22) PCT Filed: Jan. 5, 2021
(86) PCT No.: PCT/CN2021/070259

§ 371 Date: May 23, 2023

(51) Int. Cl. H04W 36/00

(52) U.S. Cl. CPC H04W 36/033; H04W 88/04

(57) ABSTRACT

Methods, systems, and devices for wireless communications are described. A base station may identify a relay pairing between a user equipment (UE) and a relay UE. The base station may additionally identify a configuration of the relay UE based on a handover decision associated with the relay pairing. The base station may indicate, to the UE, the configuration of the relay UE, an identifier of the relay UE, and that the UE is to switch to a sidelink communications link with the relay UE. The UE may then establish the sidelink communications link with the relay UE and may indicate, to the relay UE, that the sidelink communication link is for a handover associated with the relay pairing. Based on receiving the indication that the sidelink communication link is for the handover associated with the relay pairing, the relay UE may perform a connection setup procedure with the base station.

### CROSS REFERENCE

The present Application is a 371 national stage filing of International PCT Application No. PCT/CN2021/070259 by Cheng et al. entitled “FORWARD HANDOVER PROCEDURES FOR L2 RELAY MOBILITY,” filed Jan. 5, 2021, which is assigned to the assignee hereof, and which is expressly incorporated by reference in its entirety herein.

### FIELD OF TECHNOLOGY

The following relates to wireless communications, including forward handover procedures for layer 2 (L2) relay mobility.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

Some wireless communications networks may support relayed or sidelink communications to extend coverage and increase reliability between devices in the network. Conventional techniques for establishing and maintaining the sidelink, however, may be deficient.

### SUMMARY

The described techniques relate to improved methods, systems, devices, and apparatuses that support handover procedures (e.g., forward handover procedures) for layer 2 (L2) relay mobility. Generally, the described techniques provide for a user equipment (UE) (e.g., a remote UE) communicating with a base station via a relay UE. A base station may identify a handover decision to switch the remote UE from communicating directly with the base station to communicating with the base station via a relay UE. In some cases, the base station may select the relay UE from a set of candidate relay UEs to enable the remote UE to communicate with the base station via the relay UE. The base station may additionally identify a configuration of the relay UE based on the handover decision associated with the relay pairing. The base station may indicate, to the remote UE, the configuration of the relay UE, an identifier of the relay UE, and that the remote UE is to switch to a sidelink communications link with the relay UE. The remote UE may then establish the sidelink communications link with the relay UE and may indicate, to the relay UE, that the sidelink communication link is for the handover associated with the relay pairing. Based on receiving the indication that the sidelink communication link is for the handover associated with the relay pairing, the relay UE may perform a connection setup procedure or a connection resumption procedure with the base station. In some cases, performing the connection setup or connection resumption procedure may trigger the relay UE to establish or resume a connection with the base station. Thus, the relay UE may transition from an idle or inactive state to a connected state, which may enable a relay link between the remote UE and the base station via the relay UE.

A method for wireless communication at a base station is described. The method may include identifying a relay pairing between a UE and a relay UE based on a measurement report from the UE, where the relay UE is from a set of one or more relay UE candidates, identifying a configuration of the relay UE based on a handover decision associated with the relay pairing, and transmitting, to the UE, a message indicating the configuration of the relay UE, an identifier of the relay UE, and an indication that the UE is to switch to a sidelink communications link with the relay UE.

An apparatus for wireless communication at a base station is described. The apparatus may include a processor, memory in electronic communication with the processor, and instructions stored in the memory. The instructions may be executable by the processor to cause the apparatus to identify a relay pairing between a UE and a relay UE based on a measurement report from the UE, where the relay UE is from a set of one or more relay UE candidates, identify a configuration of the relay UE based on a handover decision associated with the relay pairing, and transmit, to the UE, a message indicating the configuration of the relay UE, an identifier of the relay UE, and an indication that the UE is to switch to a sidelink communications link with the relay UE.

Another apparatus for wireless communication at a base station is described. The apparatus may include means for identifying a relay pairing between a UE and a relay UE based on a measurement report from the UE, where the relay UE is from a set of one or more relay UE candidates, means for identifying a configuration of the relay UE based on a handover decision associated with the relay pairing, and means for transmitting, to the UE, a message indicating the configuration of the relay UE, an identifier of the relay UE, and an indication that the UE is to switch to a sidelink communications link with the relay UE.

A non-transitory computer-readable medium storing code for wireless communication at a base station is described. The code may include instructions executable by a processor to identify a relay pairing between a UE and a relay UE based on a measurement report from the UE, where the relay UE is from a set of one or more relay UE candidates, identify a configuration of the relay UE based on a handover decision associated with the relay pairing, and transmit, to the UE, a message indicating the configuration of the relay UE, an identifier of the relay UE, and an indication that the UE is to switch to a sidelink communications link with the relay UE.

Some examples of the method, apparatuses, and non-transitory computer-readable medium described herein may further include operations, features, means, or instructions for receiving a setup request message from the relay UE based on a sidelink communication link between the UE and the relay UE, establishing a first signaling radio bearer for the relay UE based on receiving the setup request message, and transmitting, to the relay UE, a connection setup complete message including an indication of the first signaling radio bearer.

Some examples of the method, apparatuses, and non-transitory computer-readable medium described herein may further include operations, features, means, or instructions for establishing a second signaling radio bearer, or a data radio bearer, or any combination thereof, based on the configuration of the relay UE and transmitting, to the relay UE, a reconfiguration complete message including an indication of the second signaling radio bearer, or the data radio bearer, or any combination thereof.

Some examples of the method, apparatuses, and non-transitory computer-readable medium described herein may further include operations, features, means, or instructions for receiving, via the relay UE, a connection reestablishment request message from the UE based on the relay pairing between the UE and the relay UE, identifying context information associated with the relay UE, and transmitting, to the UE, a connection reestablishment message via the relay UE in response to the connection reestablishment request message, where transmitting the connection reestablishment message may be based on identifying the context information associated with the relay UE.

In some examples of the method, apparatuses, and non-transitory computer-readable medium described herein, the first signaling radio bearer, the second signaling radio bearer, the data radio bearer, or any combination thereof, may be established after receiving the connection reestablishment request message from the UE.

In some examples of the method, apparatuses, and non-transitory computer-readable medium described herein, identifying the context information associated with the relay UE may include operations, features, means, or instructions for transmitting, to an anchor base station associated with the relay UE, a request for the context information associated with the relay UE, where the request for the context information may be based on receiving the connection reestablishment request message from the UE and receiving, from the anchor base station, the context information for the relay UE based on the request for the context information.

Some examples of the method, apparatuses, and non-transitory computer-readable medium described herein may further include operations, features, means, or instructions for receiving the measurement report from the UE, where the measurement report includes an indication of a connection state of the relay UE, the identifier of the relay UE, a cell identifier of the relay UE, or any combination thereof, where the relay pairing may be based on the measurement report.

Some examples of the method, apparatuses, and non-transitory computer-readable medium described herein may further include operations, features, means, or instructions for generating a handover command for the UE based on the handover decision.

Some examples of the method, apparatuses, and non-transitory computer-readable medium described herein may further include operations, features, means, or instructions for storing a L2 identifier of the UE and a L2 identifier of the relay UE based on the relay pairing and releasing an access link with the UE based on storing the L2 identifier of the UE and the L2 identifier or the relay UE.

In some examples of the method, apparatuses, and non-transitory computer-readable medium described herein, the message includes a radio resource control (RRC) reconfiguration message.

In some examples of the method, apparatuses, and non-transitory computer-readable medium described herein, a connection state of the relay UE includes an idle state or an inactive state.

A method for wireless communication at a relay UE is described. The method may include receiving, from a UE, a message to establish a sidelink communication link with the UE, where the message includes an indication that the sidelink communication link is for a handover associated with a relay pairing between the UE and the relay UE, transmitting, to a base station, a connection setup request message based on establishing the sidelink communication link with the UE, and receiving, from the base station in response to the connection setup request message, a connection setup complete message including an indication of a first signaling radio bearer associated with a relay link for the relay pairing.

An apparatus for wireless communication at a relay UE is described. The apparatus may include a processor, memory in electronic communication with the processor, and instructions stored in the memory. The instructions may be executable by the processor to cause the apparatus to receive, from a UE, a message to establish a sidelink communication link with the UE, where the message includes an indication that the sidelink communication link is for a handover associated with a relay pairing between the UE and the relay UE, transmit, to a base station, a connection setup request message based on establishing the sidelink communication link with the UE, and receive, from the base station in response to the connection setup request message, a connection setup complete message including an indication of a first signaling radio bearer associated with a relay link for the relay pairing.

Another apparatus for wireless communication at a relay UE is described. The apparatus may include means for receiving, from a UE, a message to establish a sidelink communication link with the UE, where the message includes an indication that the sidelink communication link is for a handover associated with a relay pairing between the UE and the relay UE, means for transmitting, to a base station, a connection setup request message based on establishing the sidelink communication link with the UE, and means for receiving, from the base station in response to the connection setup request message, a connection setup complete message including an indication of a first signaling radio bearer associated with a relay link for the relay pairing.

A non-transitory computer-readable medium storing code for wireless communication at a relay UE is described. The code may include instructions executable by a processor to receive, from a UE, a message to establish a sidelink communication link with the UE, where the message includes an indication that the sidelink communication link is for a handover associated with a relay pairing between the UE and the relay UE, transmit, to a base station, a connection setup request message based on establishing the sidelink communication link with the UE, and receive, from the base station in response to the connection setup request message, a connection setup complete message including an indication of a first signaling radio bearer associated with a relay link for the relay pairing.

Some examples of the method, apparatuses, and non-transitory computer-readable medium described herein may further include operations, features, means, or instructions for transmitting a reconfiguration request message to the base station based on receiving the connection setup complete message and receiving, from the base station, a reconfiguration complete message including an indication of a second signaling radio bearer for the relay link, or a data radio bearer for the relay link, or any combination thereof.

Some examples of the method, apparatuses, and non-transitory computer-readable medium described herein may further include operations, features, means, or instructions for relaying, from the UE, a connection reestablishment request message to the base station based on the relay pairing between the UE and the relay UE and relaying, from the base station, a connection reestablishment message to the UE in response to the connection reestablishment request message.

In some examples of the method, apparatuses, and non-transitory computer-readable medium described herein, the connection reestablishment request message and the connection reestablishment message may be relayed before receiving the reconfiguration complete message from the base station.

In some examples of the method, apparatuses, and non-transitory computer-readable medium described herein, a connection state of the relay UE includes an idle state or an inactive state.

A method for wireless communications at a UE is described. The method may include receiving, from a base station, a first message indicating a configuration of a relay UE, an identifier of the relay UE, and an indication for the UE to switch to a sidelink communications link with the relay UE, where the first message is based on a relay pairing between the UE and the relay UE, transmitting, to the relay UE, a second message to establish a sidelink communication link with the relay UE, where the second message includes an indication that the sidelink communication link is for a handover associated with the relay pairing, and receiving, from the relay UE and in response to the second message, a third message configuring the sidelink communication link with the relay UE.

An apparatus for wireless communications at a UE is described. The apparatus may include a processor, memory in electronic communication with the processor, and instructions stored in the memory. The instructions may be executable by the processor to cause the apparatus to receive, from a base station, a first message indicating a configuration of a relay UE, an identifier of the relay UE, and an indication for the UE to switch to a sidelink communications link with the relay UE, where the first message is based on a relay pairing between the UE and the relay UE, transmit, to the relay UE, a second message to establish a sidelink communication link with the relay UE, where the second message includes an indication that the sidelink communication link is for a handover associated with the relay pairing, and receive, from the relay UE and in response to the second message, a third message configuring the sidelink communication link with the relay UE.

Another apparatus for wireless communications at a UE is described. The apparatus may include means for receiving, from a base station, a first message indicating a configuration of a relay UE, an identifier of the relay UE, and an indication for the UE to switch to a sidelink communications link with the relay UE, where the first message is based on a relay pairing between the UE and the relay UE, means for transmitting, to the relay UE, a second message to establish a sidelink communication link with the relay UE, where the second message includes an indication that the sidelink communication link is for a handover associated with the relay pairing, and means for receiving, from the relay UE and in response to the second message, a third message configuring the sidelink communication link with the relay UE.

A non-transitory computer-readable medium storing code for wireless communications at a UE is described. The code may include instructions executable by a processor to receive, from a base station, a first message indicating a configuration of a relay UE, an identifier of the relay UE, and an indication for the UE to switch to a sidelink communications link with the relay UE, where the first message is based on a relay pairing between the UE and the relay UE, transmit, to the relay UE, a second message to establish a sidelink communication link with the relay UE, where the second message includes an indication that the sidelink communication link is for a handover associated with the relay pairing, and receive, from the relay UE and in response to the second message, a third message configuring the sidelink communication link with the relay UE.

Some examples of the method, apparatuses, and non-transitory computer-readable medium described herein may further include operations, features, means, or instructions for transmitting a measurement report to the base station, where the measurement report includes an indication of a connection state of the relay UE, the identifier of the relay UE, a cell identifier of the relay UE, or any combination thereof, where the relay pairing may be based on the measurement report.

Some examples of the method, apparatuses, and non-transitory computer-readable medium described herein may further include operations, features, means, or instructions for transmitting, via the relay UE, a connection reestablishment request message to the base station based on the relay pairing between the UE and the relay UE and receiving, from the base station, a connection reestablishment message via the relay UE in response to the connection reestablishment request message.

Some examples of the method, apparatuses, and non-transitory computer-readable medium described herein may further include operations, features, means, or instructions for releasing an access link between the UE and a source base station based on receiving the connection reestablishment message via the relay UE, where the source base station may be different from the base station.

Some examples of the method, apparatuses, and non-transitory computer-readable medium described herein may further include operations, features, means, or instructions for releasing an access link between the UE and a source base station based on receiving the first message, where the source base station may be different from the base station.

### BRIEF DESCRIPTION OF THE DRAWINGS

FIG. 1 illustrates an example of a wireless communications system that supports forward handover procedures for layer 2 (L2) relay mobility in accordance with aspects of the present disclosure.

FIG. 2 illustrates an example of a wireless communications system that supports forward handover procedures for L2 relay mobility in accordance with aspects of the present disclosure.

FIGS. 3 and 4 illustrate example process flows in a system that support forward handover procedures for L2 relay mobility in accordance with aspects of the present disclosure.

FIGS. 5 and 6 show block diagrams of devices that support forward handover procedures for L2 relay mobility in accordance with aspects of the present disclosure.

FIG. 7 shows a block diagram of a communications manager that supports forward handover procedures for L2 relay mobility in accordance with aspects of the present disclosure.

FIG. 8 shows a diagram of a system including a device that supports forward handover procedures for L2 relay mobility in accordance with aspects of the present disclosure.

FIGS. 9 and 10 show block diagrams of devices that support forward handover procedures for L2 relay mobility in accordance with aspects of the present disclosure.

FIG. 11 shows a block diagram of a communications manager that supports forward handover procedures for L2 relay mobility in accordance with aspects of the present disclosure.

FIG. 12 shows a diagram of a system including a device that supports forward handover procedures for L2 relay mobility in accordance with aspects of the present disclosure.

FIGS. 13 through 17 show flowcharts illustrating methods that support forward handover procedures for L2 relay mobility in accordance with aspects of the present disclosure.

### DETAILED DESCRIPTION

In some wireless communications networks, a user equipment (UE) may utilize Device-to-Device (D2D) communications (which may also be referred to as sidelink communications), where a first UE may transmit data via a direct link or sidelink to a second UE in the network. In some cases, sidelink communications may enable one or more remote UEs (for example, UEs that are out-of-coverage of the wireless network) to communicate with the network via a relay UE (for example, a UE that is in-coverage of the wireless network). In some cases, relayed communications may efficiently redirect traffic to and from remote UEs in proximity of the network and thus may extend coverage of the wireless network.

To establish a relay connection between a UE and a relay UE, a base station may identify a relay pairing between the UE and the relay UE (e.g., from a set of relay UE candidates). For example, the UE may transmit one or more measurement reports to the base station. In some aspects, the remote UE may be mobile and may provide measurement reporting to the base station based on the UE's mobility (e.g., including measurements of one or more potential relay UEs while the UE is mobile). In some cases, the base station may identify a decision to handover the UE from communicating directly with the base station to communicating with the base station via a relay UE (e.g., based on the measurement report). Additionally, based on the measurement report(s) the base station may identify a relay pairing and a configuration of the relay UE associated with the relay pairing. The base station may then transmit a message to the UE indicating the configuration of the relay UE and an indication that the UE is to switch to a sidelink communications link with the relay UE.

In some instances, however, the relay UE may be in an inactive or idle connection state. In these instances, the relay UE may not be in a connected state and may therefore be unable to relay communications between the remote UE and the base stations. Here, the relay UE may be triggered to enter into a connected state (e.g., by performing a connection setup or connection resumption procedure with the base station) after establishing the sidelink communications link with the relay UE. For example, during the sidelink communications link setup procedure between the remote UE and the relay UE, the remote UE may indicate that the sidelink communications link is for the handover associated with the relay pairing between the remote UE and the relay UE.

Aspects of the disclosure are initially described in the context of wireless communications systems. Aspects of the disclosure are then described in the context of process flows. Aspects of the disclosure are further illustrated by and described with reference to apparatus diagrams, system diagrams, and flowcharts that relate to forward handover procedures for layer 2 (L2) relay mobility.

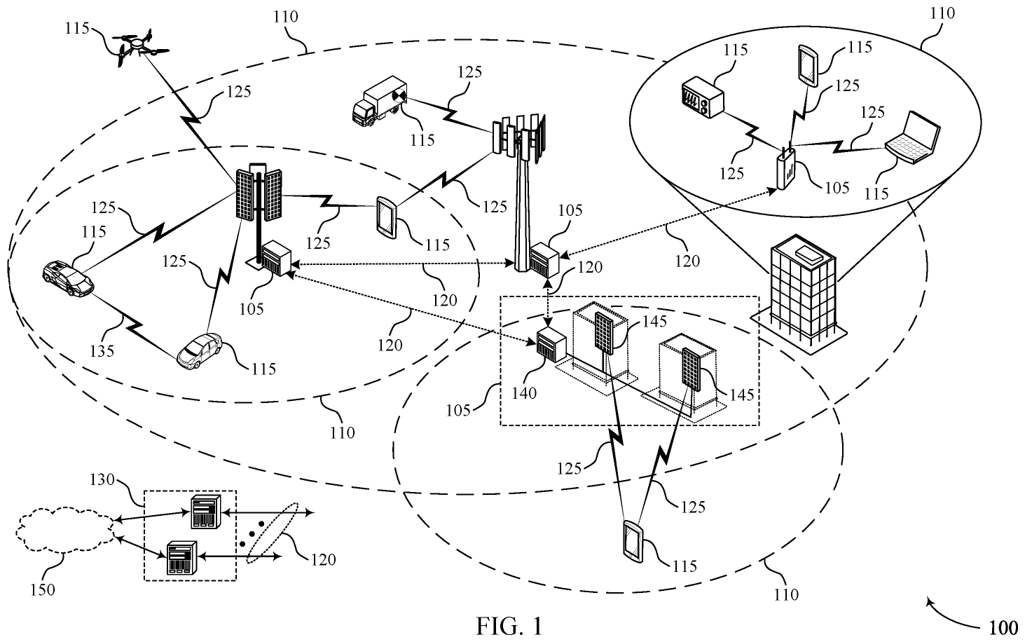

FIG. 1 illustrates an example of a wireless communications system 100 that supports forward handover procedures for L2 relay mobility in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof. Wireless communications system 100 may support triggering of connection establishment or connection resumption procedures through a remote UE establishing a sidelink with a relay UE that is in an idle or inactive state.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may include one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, for example, in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some cases, a UE 115 may be transferred from a serving base station 105 (known as the source base station) to another base station 105 (known as the target base station). For example, the UE 115 may be moving into the coverage area of the target base station 105, or the target base station 105 may be capable of providing better service for the UE 115 or relieving the source base station 105 of excess load. The transition may be referred to as a “handover.” Prior to a handover, the source base station 105 may configure the UE 115 with procedures for measuring the signal quality of neighboring base stations 105. The UE 115 may then respond with a measurement report. The source base station 105 may use the measurement report to make the handover decision. The decision may also be based on radio resource management (RRM) factors such as network load and interference mitigation. When the handover decision is made, the source base station 105 may send a handover request message to the target base station 105, which may include context information to prepare the target base station 105 to serve the UE 115. The target base station 105 may make an admission control decision, for example, to ensure that it can meet the quality of service (QoS) standards of the UE 115. The target base station 105 may then configure resources for the incoming UE 115, and send a handover request acknowledge message to the source base station 105, which may include RRC information to be passed on to the UE 115. The source base station 105 may then direct the UE 115 to perform the handover, and pass a status transfer message to the target base station with packet data convergence protocol (PDCP) bearer status information. The UE 115 may attach to the target base station via a random access procedure.

A UE 115 may operate in accordance with various states or modes for communicating with a network. As an example, a UE 115 may operate in an RRC idle state (e.g., RRC_IDLE), an RRC inactive state (e.g., RRC_INACTIVE), and/or an RRC connected state (e.g., RRC_CONNECTED). The UE 115 may transition between the various states or modes, for example, based on communications traffic for the UE 115. In the RRC idle state (which may be referred to as an idle mode), a UE 115 may not be registered to a particular cell, and may accordingly lack an access stratum (AS) context, and the UE 115 may thus not have an active RRC connection established with the network (e.g., via a base station 105). In the idle mode, the UE 115 may wake up periodically to monitor channels for paging or other signaling, and the mobility of the UE 115 may be managed by the UE 115 when performing measurements of one or more cells. In the RRC connected state (which may be referred to as a connected mode), the UE 115 may have an established RRC connection (e.g., with a 5GC) where the UE 115 may store an AS context. Here, the UE 115 may belong to a known cell and may be identified using a cell radio network temporary identifier (C-RNTI) assigned to the UE 115. While in the connected mode, the UE 115 may monitor for messages transmitted by the network, which may include monitoring various channels (e.g., paging channels, control channels, or the like).

The RRC inactive state may be used to reduce signaling overhead and may provide an intermediate mode or state (e.g., between idle and connected), which may also be used to reduced latency when transitioning to another state (e.g., to the connected state). The UE 115 may periodically wake up while in the inactive state to monitor for paging messages from the network, where the UE 115 may, in some cases, perform a random access procedure to move to the connected mode and communicate with the network.

In wireless communications system 100, a UE 115 may utilize D2D communications, which may also be referred to as sidelink communications (e.g., communications over a sidelink communication link), where a first UE 115 may transmit data via a direct link or sidelink to a second UE 115 in the network. In some cases, sidelink communications may enable one or more remote UEs 115 (for example, UEs 115 that are out-of-coverage of the wireless network) to communicate with the network via a relay UE 115 (for example, a UE 115 that is in-coverage of the wireless network). In some cases, relayed communications may efficiently redirect traffic to and from remote UEs 115 in proximity of the network and thus may extend coverage of the wireless network.

To establish a relay connection between a UE 115 and a relay UE 115, a base station 105 may identify a relay pairing between the UE 115 and the relay UE 115 (e.g., from a set of relay UE candidates). For example, the UE 115 may transmit one or more measurement reports to the base station 105. In some aspects, the remote UE 115 may be mobile and may provide measurement reporting to the base station based on the mobility of the UE 115 (e.g., including measurements of one or more potential relay UEs 115 while the UE 115 is mobile). In some cases, the base station 105 may determine to handover the UE 115 from communicating directly with the base station 105 to communicating with the base station 105 via a relay UE 115 (e.g., based on the measurement report). Additionally, based on the measurement report(s) the base station 105 may identify a relay pairing and a configuration of the relay UE 115 associated with the relay pairing. The base station 105 may then transmit a message to the UE 115 indicating the configuration of the relay UE 115 and an indication that the UE 115 is to switch to a sidelink communications link with the relay UE 115.

In some instances, however, the relay UE 115 may be in an inactive or idle connection state. In these instances, the relay UE 115 may not be in a connected state and may therefore be unable to relay communications between the remote UE 115 and the base stations 105. Here, the relay UE 115 may be triggered to enter into a connected state (e.g., by performing a connection setup or connection resumption procedure with the base station 105) after establishing the sidelink communications link with the relay UE 115. For example, during the sidelink communications link setup procedure between the remote UE 115 and the relay UE 115, the remote UE 115 may indicate that the sidelink communications link is for the handover associated with the relay pairing between the remote UE 115 and the relay UE 115. Based on receiving the indication that the sidelink communications link is for the handover associated with the relay pairing, the relay UE 115 may then perform a connection setup or connection resumption procedure with the base station 115 to enter into a connected state.

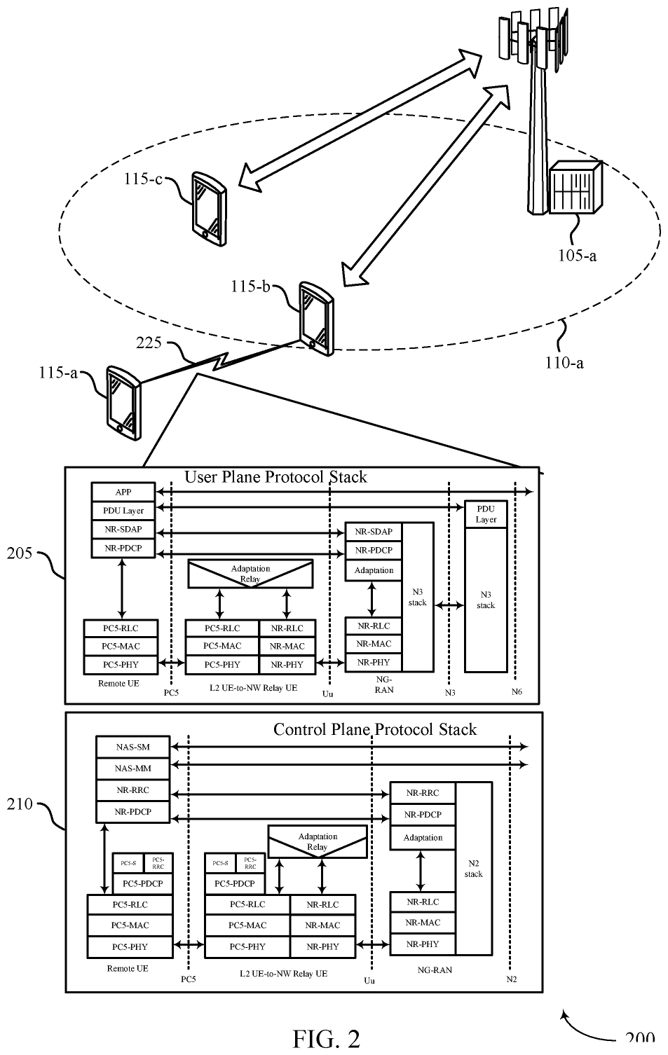

FIG. 2 illustrates an example of a wireless communications system 200 that supports forward handover procedures for L2 relay mobility in accordance with aspects of the present disclosure. In some examples, wireless communications system 200 may implement aspects of wireless communications system 100. For example, the wireless communications system 200 may include a base station 105-a and UEs 115-a, 115-b, and 115-c, which may be examples of base stations 105 and UEs 115 as described with reference to FIG. 1. Base station 105-a may serve a number of cells or geographic coverage areas (for example, geographic coverage area 110-a).

In wireless communications system 200, UEs 115 may utilize D2D communications, where a first UE 115-a may transmit data via a direct link or sidelink to a second UE 115-b in the network coverage area 110-a. In some cases, sidelink communications may enable remote UEs 115 (e.g., such as a UE 115-a that is out of coverage of the wireless network) to communicate with the network via a relay UE 115 (e.g., such as UE 115-b or 115-c that is in-coverage of the wireless network). In some cases, relayed communications may efficiently redirect traffic to and from remote UEs 115 in proximity of the network and may extend coverage of the wireless network.

In some examples, relay selection may be performed in accordance with L2 routing. During an L2 relay procedure, the relay UE 115-b may relay data below the PDCP layer. The user plane protocol stack 205 associated with the L2 relay includes a protocol data unit (PDU) connected to a PDCP layer which is connected to a sidelink RLC layer. PDUs provided by the RLC layer are directed to a device to network (D2N) MAC entity or a D2D MAC entity. The D2D MAC may provide a connection to the base station 105-a via a Uu interface, and the D2D MAC connects to relay UE 115-b via a sidelink 225 (e.g., PC5). In some examples, the relay UE 115-b may forward the PC5 bearer and the Uu bearer using an adaptation layer function. In the user plane protocol stack 205, traffic may terminate at the core network which may prevent direct communication between the remote UE 115-a (e.g., data radio bearers of the remote UE 115-a may be controlled by the network). In addition, in the user plane protocol stack 205, the network may be aware of the relay configuration between the remote UE 115-a and a number of relay UE candidates 115-b and 115-c, and may select a sidelink relay pairing (e.g., a pairing between remote UE 115-a and relay UE 115-b) based on link strength or quality of the relay link. Such relay selection by the network may increase the quality and reliability of relayed communications and may further extend coverage of the wireless communications system.

In the control plane protocol stack 210, the remote UE 115-a may include both the PC5 C-plane and the NR Uu C-plane. In some cases, the PC5 C-plane may be for setting up a unicast link prior to communicating with the base station 105-a via the relay UE 115-b. In some instances, the remote UE 115-a may support NR Uu access stratum (AS) and non-access stratum (NAS) connections (e.g., above the PC5 RLC layer). Additionally, the NG-RAN may control the sidelink 225 (e.g., the PC5 link) via NR RRC. In some instances, the adaptation layer may support multiplexing traffic associated with multiple UEs 115 on the relay UE 115-b Uu interface.

In some cases, the UE 115-a may be in direct communication with the base station 105-a prior to communicating with the base station 105-a via the relay UE 115-b. For example, the UE 115-a may communicate uplink and downlink communications directly with the base station 105-a. When the UE 115-a is communicating directly with the base station 105-a, the UE 115-a may transmit a measurement report to the base station 105-a. Additionally or alternatively, the UE 115-a may be mobile and may transmit a measurement report to the base station 105-a, where the measurement report may provide information on nearby candidate UEs 115 that may be selected for a relay pairing (e.g., based on the mobility of UE 115-a). The measurement report may indicate one or more parameters associated with each of the candidate relay UEs 115-b and 115-c. For example, the measurement report may indicate a connection state of the relay UEs 115-b and 115-c, an identifier of each relay UE 115-b and 115-c, and an indication of context information for the relay UEs 115-b and 115-c.

Based on receiving the measurement report from the UE 115-a, the base station 105-a may determine to perform a handover with the UE 115-a to switch from communicating directly with the UE 115-a to communicating with the UE 115-a via the relay UE 115-b. For example, the base station 105-a may identify a relay pairing between the UE 115-a and the relay UE 115-b. In some cases, the base station 105-a may determine to perform the handover based on determining that a signal quality for communications between the UE 115-a and the base station 105-a may be improved by performing the handover. Additionally, based on the measurement report, the base station 105-a may identify a relay pairing and a configuration of the relay UE 115-b associated with the relay pairing. The base station 105-a may then transmit a message to the UE 115-a indicating the configuration of the relay UE 115-b and an indication that the UE 115-a is to switch to a sidelink communications link with the relay UE 115-b.

In some instances, however, the relay UE 115-b may be in an inactive or idle connection state (e.g., RRC_INACTIVE or RRC_IDLE). In a case that the relay UE 115-b is in an inactive or idle state, the relay UE 115-b may be unable relay communications between the UE 115-a and the base station 105-a. For the relay UE 115-b to transition to a connected state, the relay UE 115-b may perform an RRC setup procedure (e.g., to transition from an idle state to a connected state) or an RRC resumption procedure (e.g., to transition from an inactive state to a connected state) with the base station 105-a.

The relay UE 115-b may be triggered to perform the RRC setup procedure or the RRC resumption procedure with the base station 105-a based on a sidelink setup procedure with the UE 115-a. For example, the UE 115-a may determine to perform the sidelink setup procedure with the relay UE 115-b based on receiving the message from the base station 105-a indicating the configuration of the relay UE 115-b and the indication that the UE 115-a is to switch to the sidelink communications link with the relay UE 115-b. During the sidelink setup procedure between the UE 115-a and 115-b, the UE 115-a may transmit a message to establish the sidelink communication link with the UE 115-b, where the message includes an indication that the sidelink communication link is for the handover associated with the relay pairing. Based on receiving the indication that the sidelink communication link is for the handover procedure, the relay UE 115-b may perform a connection setup procedure (e.g., an RRC setup procedure, an RRC resumption procedure) with the base station 105-a. Thus, the relay UE 115-b may transition into a connected state, enabling the relay UE 115-b to relay communications between the UE 115-a and the base station 105-a.

In some cases, the handover to switch from communicating directly with the UE 115-a to communicating with the UE 115-a via the relay UE 115-b may additionally include a handover from the source base station 105-a to a different base station 105 (e.g., a target base station 105). For example, the handover between the source and target base station 105 may be based on the mobility of the UE 115-a, based on a relay UE 115-b that is selected for the relay pairing, or for some other reasons. But in some other cases, the source and target base stations 105 may the same base station 105-a.

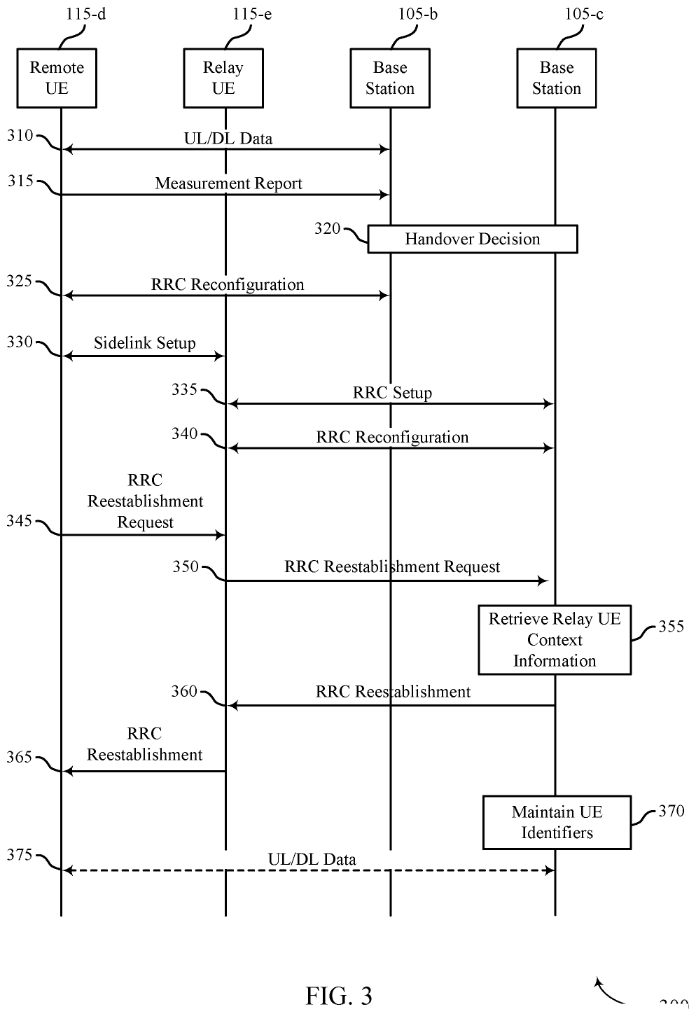

FIG. 3 illustrates an example of a process flow 300 in a system that supports forward handover procedures for L2 relay mobility in accordance with aspects of the present disclosure. The process flow 300 includes UEs 115-d and 115-e and base stations 105-b and 105-c, which may be examples of the corresponding devices described with reference to FIGS. 1-2. In some cases, the source base station 105-b and the target base station 105-c may be the same base station 105. Alternative examples of the following may be implemented, where some steps are performed in a different order than described or are not performed at all. In some cases, steps may include additional features not mentioned below, or further steps may be added.

The process flow 300 illustrates an example of a forward handover procedure (e.g., initiated by the remote UE 115-d) to switch the remote UE 115-d from communicating directly with the base station 105-b to communicating with the base station 105-c via the relay UE 115-e in a case that the relay UE 115-e is in an idle state (e.g., RRC_IDLE).

At 310, the remote UE 115-d may communicate directly with the base station 105-b (e.g., a source base station 105-b). For example, the remote UE 115-d may transmit uplink data to the base station 105-b and the base station 105-b may transmit downlink data to the remote UE 115-d.

At 315, the remote UE 115-d may transmit a measurement report (e.g., a mobility trigger) to the base station 105-b. The measurement report may include an indication of the connection state of the relay UE 115-e (e.g., an RRC state of the relay UE 115-e), an identifier of the relay UE 115-e, a cell identifier of the relay UE 115-e, or any combination thereof. In some cases, the identifier of the relay UE 115-e may include a serving temporary mobile subscriber identity (S-TMSI), such as a 5G-S-TMSI, or a hashed version of a 5G-S-TMSI, or the like.

At 320, the source base station 105-b and the target base station 105-c may make a handover decision. For example, the base stations 105-b and 105-c may determine to handover the remote UE 115-d from communicating directly with the source base station 105-b to communicating with the target base station 105-c via the relay UE 115-e. In some cases, the source base station 105-b and the target base station 105-c may be the same. Here, the handover decision may relate to switching the remote UE 115-d from communicating directly with the base station 105 to communicating with the base station 105 via the relay UE 115-e (e.g., a Uu to PC5 handover). In either case, when the source base station 105-b makes the handover decision, the base station 105-b may identify a relay pairing between the remote UE 115-d and the relay UE 115-e. Additionally, the source base station 105-b may identify a configuration of the relay UE 115-e based on the handover decision associated with the relay pairing between the remote UE 115-d and the relay UE 115-e.

At 325, the remote UE 115-d and the source base station 105-b may perform an RRC reconfiguration procedure. For example, the source base station 105-b may transmit a message indicating the configuration of the relay UE 115-e, an identifier of the relay UE 115-e, and an indication that the remote UE 115-d is to switch to a sidelink communications link (e.g., a PC5 link) with the relay UE 115-e. In some cases, the remote UE 115-d may release an access link (e.g., a Uu connection) with the source base station 105-b after performing the RRC reconfiguration procedure at 325.

At 330, the remote UE 115-d and the relay UE 115-e may establish (e.g., setup and configure) the sidelink channel (e.g., the PC5 channel) based on the remote UE 115-d receiving the message from the source base station 105-b as part of the RRC reconfiguration procedure. In some instances, the remote UE 115-d may initiate the setup of the sidelink channel by transmitting, to the relay UE 115-e, a message to establish the sidelink communication link with the relay UE 115-e, where the message includes an indication that the sidelink communication link is for a handover associated with the relay pairing.

At 335, the relay UE 115-e and the target base station 105-c may perform an RRC setup procedure. In some cases, the relay UE 115-e may determine to perform the RRC setup procedure with the target base station 105-c in response to receiving the indication (e.g., from the remote UE 115-d at 330) that the sidelink communication link is for a handover associated with the relay pairing. During the RRC setup procedure, the relay UE 115-e may transmit an RRC setup request message to the target base station 105-c. The target base station 105-c may establish a first signaling radio bearer (e.g., SRB0) for the relay UE 115-e based on receiving the RRC setup request message. The target base station 105-c may then transmit, to the relay UE 115-e, an RRC connection setup complete message including an indication of the first signaling radio bearer.

At 340, the relay UE 115-e and the target base station 105-c may perform an RRC reconfiguration procedure. For example, the relay UE 115-e may transmit an RRC reconfiguration request message to the target base station 105-c based on receiving the RRC connection setup complete message (e.g., at 335). The target base station 105-c may then establish a second signaling radio bearer for the relay link (e.g., SRB1), a data radio bearer for the relay link (e.g., DRB), or both, based on the configuration of the relay UE 115-e and receiving the RRC reconfiguration request message. The target base station 105-c may then transmit an RRC reconfiguration complete message to the relay UE 115-e, where the RRC reconfiguration complete message includes an indication of the second signaling radio bearer for the relay link, the data radio bearer for the relay link, or both.

At 345 and 350, the remote UE 115-d may transmit an RRC connection reestablishment request to the target base station 105-c. For example, at 345, the remote UE 115-d may transit the RRC connection reestablishment request to the relay UE 115-e and at 350, the relay UE 115-e may relay (e.g., forward) the RRC connection reestablishment request to the target base station 105-c. In some instances, the remote UE 115-d may transmit the RRC reestablishment request to the relay UE 115-e prior to the relay UE 115-e and the target base station 105-c performing the RRC setup and the RRC reconfiguration procedures (e.g., at 335 and 340). Here, the relay UE 115-e and target base station 105-c may perform the RRC setup and RRC reconfiguration procedures after the relay UE 115-e receives the RRC connection reestablishment request from the remote UE 115-d at 345 (e.g., and before the relay UE 115-e relays the RRC connection reestablishment request to the target base station 105-c).

At 355, the target base station 105-c may identify context information associated with the relay UE 115-e based on receiving the RRC connection reestablishment request from the remote UE 115-d via the relay UE 115-e.

At 360 and 365, the target base station 105-c may transmit an RRC connection reestablishment message to the remote UE 115-d via the relay UE 115-e based on identifying the context information associated with the relay UE 115-e. For example, at 360 the target base station 105-c may transmit the RRC connection reestablishment message to the relay UE 115-e and at 365, the relay UE 115-e may relay (e.g., forward) the RRC connection reestablishment message to the remote UE 115-d. In some cases, the remote UE 115-d may release an access link (e.g., a Uu connection) with the source base station 105-b after receiving the RRC connection reestablishment message from the target base station 105-c at 365.

At 370, the target base station 105-c may maintain identifiers (e.g., L2 identifiers) for the relay UE 115-e and the remote UE 115-d (e.g., based on receiving the RRC reconfiguration complete message from the remote UE 115-d via the relay UE 115-e).

At 375, the remote UE 115-d may optionally communicate with the target base station 105-c via the relay UE 115-e. For example, the remote UE 115-d may transmit uplink data to the target base station 105-c via the relay UE 115-e. Additionally, the base station 105-c may transmit downlink data to the remote UE 115-d via the relay UE 115-e.

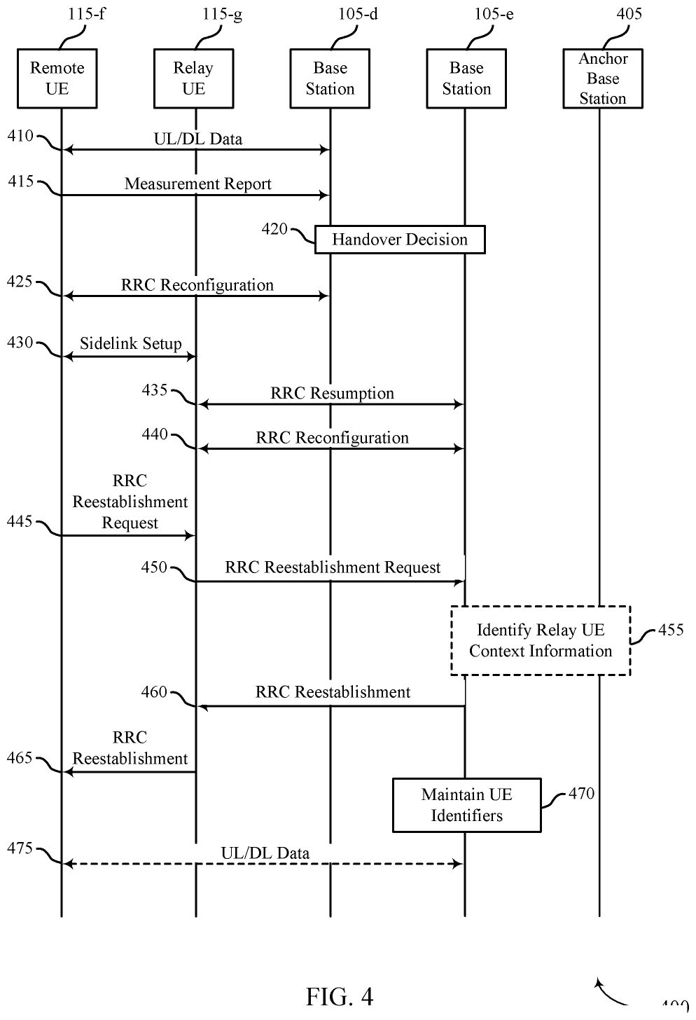

FIG. 4 illustrates an example of a process flow 400 in a system that supports forward handover procedures for L2 relay mobility in accordance with aspects of the present disclosure. The process flow 400 includes UEs 115-f and 115-g and base stations 105-d and 105-e, which may be examples of the corresponding devices described with reference to FIGS. 1-2. The process flow 400 may additionally include an anchor base station 405 associated with the relay UE 115-g. In some cases, the source base station 105-d and the target base station 105-e may be the same base station 105. Additionally or alternatively, the target base station 105-e and the anchor base station 405 may be the same base station 105. Alternative examples of the following may be implemented, where some steps are performed in a different order than described or are not performed at all. In some cases, steps may include additional features not mentioned below, or further steps may be added.

The process flow 400 may illustrate an example of a forward handover procedure (e.g., initiated by a remote UE 115-f) to switch the remote UE 115-f from communicating directly with the base station 105-d to communicating with the base station 105-e via the relay UE 115-g in a case that the relay UE 115-g is in an inactive state (e.g., RRC_INACTIVE).

At 410, the remote UE 115-f may communicate directly with the base station 105-d (e.g., a source base station 105-d). For example, the remote UE 115-f may transmit uplink data to the base station 105-d and the base station 105-d may transmit downlink data to the remote UE 115-f.

At 415, the remote UE 115-f may transmit a measurement report (e.g., a mobility trigger) to the base station 105-d. The measurement report may include an indication of the connection state of the relay UE 115-g (e.g., an RRC state of the relay UE 115-g), an identifier of the relay UE 115-g, a cell identifier of the relay UE 115-g, or any combination thereof. In some cases, the identifier of the relay UE 115-g may include a radio network temporary identifier (RNTI), such as an inactive-RNTI (I-RNTI), or a hashed version of an I-RNTI, or the like.

At 420, the source base station 105-d and the target base station 105-e may make a handover decision. For example, the base stations 105-d and 105-e may determine to handover the remote UE 115-f from communicating directly with the source base station 105-d to communicating with the target base station 105-e via the relay UE 115-g. In some cases, the source base station 105-d and the target base station 105-e may be the same. Here, the handover decision may relate to switching the remote UE 115-f from communicating directly with the base station 105 to communicating with the base station 105 via the relay UE 115-g (e.g., a Uu to PC5 handover). In either case, when the source base station 105-d makes the handover decision, the base station 105-d may identify a relay pairing between the remote UE 115-f and the relay UE 115-g. Additionally, the source base station 105-d may identify a configuration of the relay UE 115-g based on the handover decision associated with the relay pairing between the remote UE 115-f and the relay UE 115-g.

At 425, the remote UE 115-f and the source base station 105-d may perform an RRC reconfiguration procedure. For example, the source base station 105-d may transmit a message indicating the configuration of the relay UE 115-g, an identifier of the relay UE 115-g, and an indication that the remote UE 115-f is to switch to a sidelink communications link (e.g., a PC5 link) with the relay UE 115-g. In some cases, the remote UE 115-f may release an access link (e.g., a Uu connection) with the source base station 105-d after performing the RRC reconfiguration procedure at 425.

At 430, the remote UE 115-f and the relay UE 115-g may establish (e.g., setup and configure) the sidelink channel (e.g., the PC5 channel) based on the remote UE 115-f receiving the message from the source base station 105-d as part of the RRC reconfiguration procedure. In some instances, the remote UE 115-f may initiate the setup of the sidelink channel by transmitting, to the relay UE 115-g, a message to establish the sidelink communication link with the relay UE 115-g, where the message includes an indication that the sidelink communication link is for a handover associated with the relay pairing.

At 435, the relay UE 115-g and the target base station 105-e may perform an RRC resumption procedure (e.g., resuming an RRC connection that was previously established). In some cases, the relay UE 115-g may determine to perform the RRC resumption procedure with the target base station 105-e in response to receiving the indication (e.g., from the remote UE 115-f at 430) that the sidelink communication link is for a handover associated with the relay pairing. During the RRC resumption procedure, the relay UE 115-g may transmit an RRC resumption request message to the target base station 105-e. The target base station 105-e may establish a first signaling radio bearer (e.g., SRB0) for the relay UE 115-g based on receiving the RRC resumption request message. The target base station 105-e may then transmit, to the relay UE 115-g, an RRC resumption complete message including an indication of the first signaling radio bearer.

At 440, the relay UE 115-g and the target base station 105-e may perform an RRC reconfiguration procedure. For example, the relay UE 115-g may transmit an RRC reconfiguration request message to the target base station 105-e based on receiving the RRC resumption complete message (e.g., at 435). The target base station 105-e may then establish a second signaling radio bearer for the relay link (e.g., SRB1), a data radio bearer for the relay link (e.g., DRB), or both based on the configuration of the relay UE 115-g and receiving the RRC reconfiguration request message. The target base station 105-e may then transmit an RRC reconfiguration complete message to the relay UE 115-g, where the RRC reconfiguration complete message includes an indication of the second signaling radio bearer for the relay link, the data radio bearer for the relay link, or both.

At 445 and 450, the remote UE 115-f may transmit an RRC connection reestablishment request to the target base station 105-e. For example, at 445, the remote UE 115-f may transit the RRC connection reestablishment request to the relay UE 115-g and at 450, the relay UE 115-g may relay (e.g., forward) the RRC connection reestablishment request to the target base station 105-e. In some instances, the remote UE 115-f may transmit the RRC reestablishment request to the relay UE 115-g prior to the relay UE 115-g and the target base station 105-e performing the RRC setup and the RRC reconfiguration procedures (e.g., at 435 and 440). Here, the relay UE 115-g and target base station 105-e may perform the RRC setup and RRC reconfiguration procedures after the relay UE 115-g receives the RRC connection reestablishment request from the remote UE 115-f at 445 (e.g., and before the relay UE 115-g relays the RRC connection reestablishment request to the target base station 105-e).

At 455, the target base station 105-e may identify context information associated with the relay UE 115-g based on receiving the RRC connection reestablishment request from the remote UE 115-f via the relay UE 115-g. In a case that the target base station 105-e is not the anchor base station 405 of the relay UE 115-g, the target base station 105-e receiving the RRC reestablishment request from the relay UE 115-g may trigger the target base station to retrieve the context information associated with the relay UE 115-g from the anchor base station 405 of the relay UE 115-g. In a case that the target base station 105-e is the same as the anchor base station 405 of the relay UE 115-g, the target base station 105-e may identify the context information associated with the relay UE 115-g.

At 460 and 465, the target base station 105-e may transmit an RRC connection reestablishment message to the remote UE 115-f via the relay UE 115-g based on identifying the context information associated with the relay UE 115-g. For example, at 460 the target base station 105-e may transmit the RRC connection reestablishment message to the relay UE 115-g and at 465, the relay UE 115-g may relay (e.g., forward) the RRC connection reestablishment message to the remote UE 115-f.

At 470, the target base station 105-e may maintain identifiers (e.g., L2 identifiers) for the relay UE 115-g and the remote UE 115-f (e.g., based on receiving the RRC reconfiguration complete message from the remote UE 115-f via the relay UE 115-g). In some cases, the remote UE 115-f may release an access link (e.g., a Uu connection) with the source base station 105-d after the base station 105-e maintains the identifiers.

At 475, the remote UE 115-f may optionally communicate with the target base station 105-e via the relay UE 115-g. For example, the remote UE 115-f may transmit uplink data to the target base station 105-e via the relay UE 115-g. Additionally, the base station 105-e may transmit downlink data to the remote UE 115-f via the relay UE 115-g.

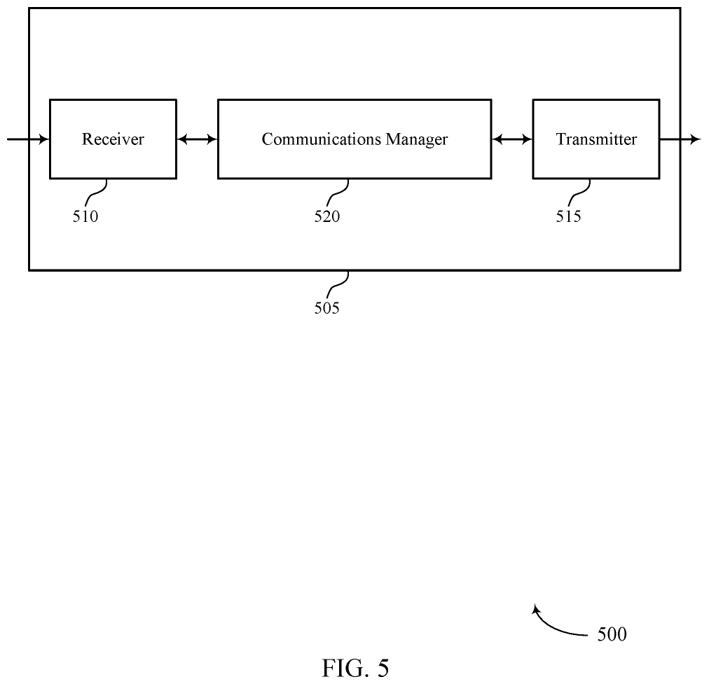

FIG. 5 shows a block diagram 500 of a device 505 that supports forward handover procedures for L2 relay mobility in accordance with aspects of the present disclosure. The device 505 may be an example of aspects of a base station 105 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to forward handover procedures for L2 relay mobility). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to forward handover procedures for L2 relay mobility). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of forward handover procedures for L2 relay mobility as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a DSP, an ASIC, a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a base station in accordance with examples as disclosed herein. For example, the communications manager 520 may be configured as or otherwise support a means for identifying a relay pairing between a UE and a relay UE based on a measurement report from the UE, where the relay UE is from a set of one or more relay UE candidates. The communications manager 520 may be configured as or otherwise support a means for identifying a configuration of the relay UE based on a handover decision associated with the relay pairing. The communications manager 520 may be configured as or otherwise support a means for transmitting, to the UE, a message indicating the configuration of the relay UE, an identifier of the relay UE, and an indication that the UE is to switch to a sidelink communications link with the relay UE.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for determining context information associated with a relay UE while maintaining a continuity of service (e.g., to a remote UE).

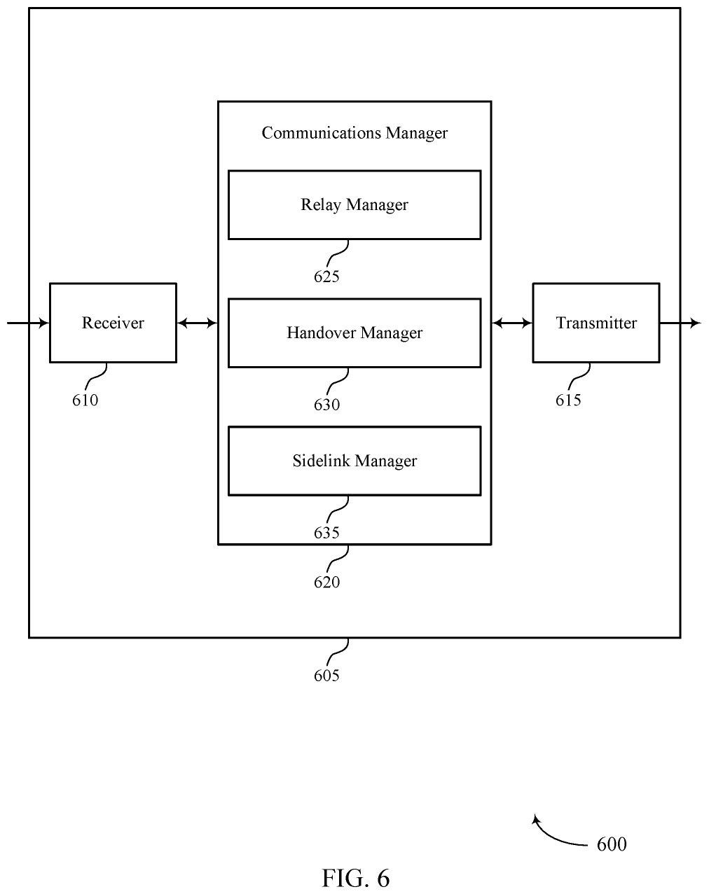

FIG. 6 shows a block diagram 600 of a device 605 that supports forward handover procedures for L2 relay mobility in accordance with aspects of the present disclosure. The device 605 may be an example of aspects of a device 505 or a base station 105 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to forward handover procedures for L2 relay mobility). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to forward handover procedures for L2 relay mobility). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of forward handover procedures for L2 relay mobility as described herein. For example, the communications manager 620 may include a relay manager 625, a handover manager 630, a sidelink manager 635, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a base station in accordance with examples as disclosed herein. The relay manager 625 may be configured as or otherwise support a means for identifying a relay pairing between a UE and a relay UE based on a measurement report from the UE, where the relay UE is from a set of one or more relay UE candidates. The handover manager 630 may be configured as or otherwise support a means for identifying a configuration of the relay UE based on a handover decision associated with the relay pairing. The sidelink manager 635 may be configured as or otherwise support a means for transmitting, to the UE, a message indicating the configuration of the relay UE, an identifier of the relay UE, and an indication that the UE is to switch to a sidelink communications link with the relay UE.

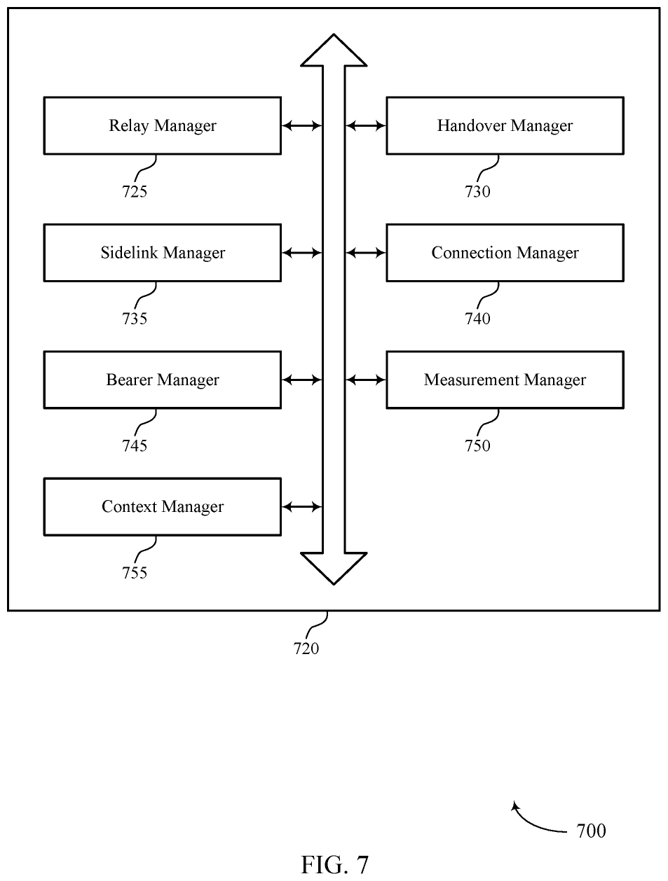

FIG. 7 shows a block diagram 700 of a communications manager 720 that supports forward handover procedures for L2 relay mobility in accordance with aspects of the present disclosure. The communications manager 720 may be an example of aspects of a communications manager 520, a communications manager 620, or both, as described herein. The communications manager 720, or various components thereof, may be an example of means for performing various aspects of forward handover procedures for L2 relay mobility as described herein. For example, the communications manager 720 may include a relay manager 725, a handover manager 730, a sidelink manager 735, a connection manager 740, a bearer manager 745, a measurement manager 750, a context manager 755, or any combination thereof. Each of these components may communicate, directly or indirectly, with one another (e.g., via one or more buses).

The communications manager 720 may support wireless communication at a base station in accordance with examples as disclosed herein. The relay manager 725 may be configured as or otherwise support a means for identifying a relay pairing between a UE and a relay UE based on a measurement report from the UE, where the relay UE is from a set of one or more relay UE candidates. The handover manager 730 may be configured as or otherwise support a means for identifying a configuration of the relay UE based on a handover decision associated with the relay pairing. The sidelink manager 735 may be configured as or otherwise support a means for transmitting, to the UE, a message indicating the configuration of the relay UE, an identifier of the relay UE, and an indication that the UE is to switch to a sidelink communications link with the relay UE.

In some examples, the connection manager 740 may be configured as or otherwise support a means for receiving a setup request message from the relay UE based on a sidelink communication link between the UE and the relay UE. In some examples, the bearer manager 745 may be configured as or otherwise support a means for establishing a first signaling radio bearer for the relay UE based on receiving the setup request message. In some examples, the connection manager 740 may be configured as or otherwise support a means for transmitting, to the relay UE, a connection setup complete message including an indication of the first signaling radio bearer.

In some examples, the bearer manager 745 may be configured as or otherwise support a means for establishing a second signaling radio bearer, or a data radio bearer, or any combination thereof, based on the configuration of the relay UE. In some examples, the connection manager 740 may be configured as or otherwise support a means for transmitting, to the relay UE, a reconfiguration complete message including an indication of the second signaling radio bearer, or the data radio bearer, or any combination thereof.

In some examples, the connection manager 740 may be configured as or otherwise support a means for receiving, via the relay UE, a connection reestablishment request message from the UE based on the relay pairing between the UE and the relay UE. In some examples, the context manager 755 may be configured as or otherwise support a means for identifying context information associated with the relay UE. In some examples, the connection manager 740 may be configured as or otherwise support a means for transmitting, to the UE, a connection reestablishment message via the relay UE in response to the connection reestablishment request message, where transmitting the connection reestablishment message is based on identifying the context information associated with the relay UE. In some examples, the first signaling radio bearer, the second signaling radio bearer, the data radio bearer, or any combination thereof, is established after receiving the connection reestablishment request message from the UE.

In some examples, to support identifying the context information associated with the relay UE, the context manager 755 may be configured as or otherwise support a means for transmitting, to an anchor base station associated with the relay UE, a request for the context information associated with the relay UE, where the request for the context information is based on receiving the connection reestablishment request message from the UE. In some examples, to support identifying the context information associated with the relay UE, the context manager 755 may be configured as or otherwise support a means for receiving, from the anchor base station, the context information for the relay UE based on the request for the context information.

In some examples, the measurement manager 750 may be configured as or otherwise support a means for receiving the measurement report from the UE, where the measurement report includes an indication of a connection state of the relay UE, the identifier of the relay UE, a cell identifier of the relay UE, or any combination thereof, where the relay pairing is based on the measurement report.

In some examples, the handover manager 730 may be configured as or otherwise support a means for generating a handover command for the UE based on the handover decision.

In some examples, the relay manager 725 may be configured as or otherwise support a means for storing an L2 identifier of the UE and an L2 identifier of the relay UE based on the relay pairing. In some examples, the connection manager 740 may be configured as or otherwise support a means for releasing an access link with the UE based on storing the L2 identifier of the UE and the L2 identifier or the relay UE.

In some examples, the message includes an RRC reconfiguration message. In some examples, a connection state of the relay UE includes an idle state or an inactive state.

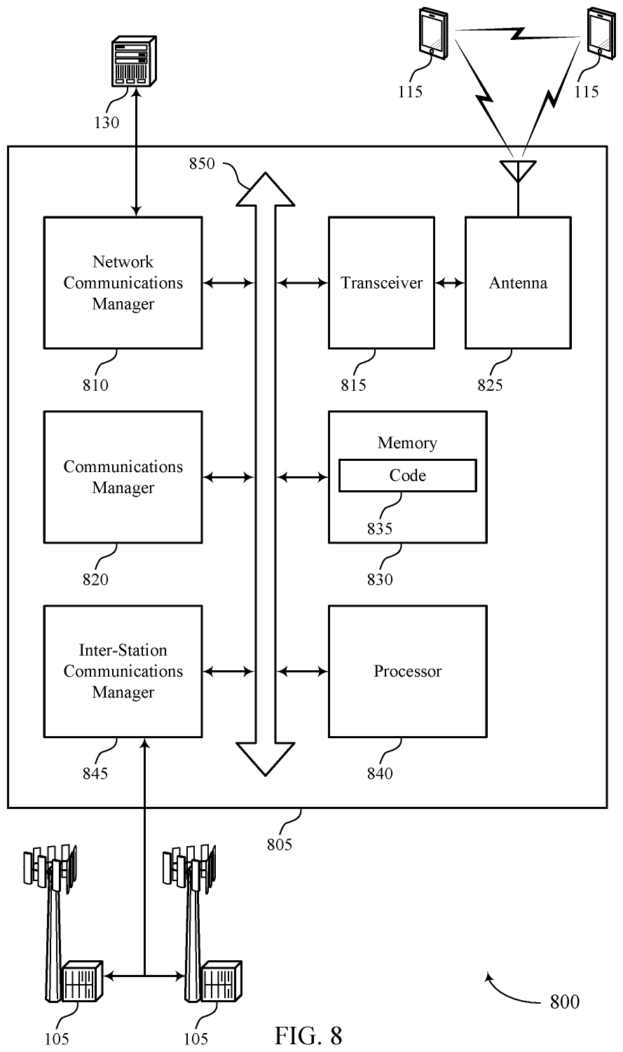

FIG. 8 shows a diagram of a system 800 including a device 805 that supports forward handover procedures for L2 relay mobility in accordance with aspects of the present disclosure. The device 805 may be an example of or include the components of a device 505, a device 605, or a base station 105 as described herein. The device 805 may communicate wirelessly with one or more base stations 105, UEs 115, or any combination thereof. The device 805 may include components for bi-directional voice and data communications including components for transmitting and receiving communications, such as a communications manager 820, a network communications manager 810, a transceiver 815, an antenna 825, a memory 830, code 835, a processor 840, and an inter-station communications manager 845. These components may be in electronic communication or otherwise coupled (e.g., operatively, communicatively, functionally, electronically, electrically) via one or more buses (e.g., a bus 850).

The network communications manager 810 may manage communications with a core network 130 (e.g., via one or more wired backhaul links). For example, the network communications manager 810 may manage the transfer of data communications for client devices, such as one or more UEs 115.

In some cases, the device 805 may include a single antenna 825. However, in some other cases the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a BIOS which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting forward handover procedures for L2 relay mobility). For example, the device 805 or a component of the device 805 may include a processor 840 and memory 830 coupled to the processor 840, the processor 840 and memory 830 configured to perform various functions described herein.

The inter-station communications manager 845 may manage communications with other base stations 105, and may include a controller or scheduler for controlling communications with UEs 115 in cooperation with other base stations 105. For example, the inter-station communications manager 845 may coordinate scheduling for transmissions to UEs 115 for various interference mitigation techniques such as beamforming or joint transmission. In some examples, the inter-station communications manager 845 may provide an X2 interface within an LTE/LTE-A wireless communications network technology to provide communication between base stations 105.

The communications manager 820 may support wireless communication at a base station in accordance with examples as disclosed herein. For example, the communications manager 820 may be configured as or otherwise support a means for identifying a relay pairing between a UE and a relay UE based on a measurement report from the UE, where the relay UE is from a set of one or more relay UE candidates. The communications manager 820 may be configured as or otherwise support a means for identifying a configuration of the relay UE based on a handover decision associated with the relay pairing. The communications manager 820 may be configured as or otherwise support a means for transmitting, to the UE, a message indicating the configuration of the relay UE, an identifier of the relay UE, and an indication that the UE is to switch to a sidelink communications link with the relay UE.

By including or configuring the communications manager 820 in accordance with examples as described herein, the device 805 may support techniques for improved coordination between devices by improving a continuity of service between a base station and a remote UE.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of forward handover procedures for L2 relay mobility as described herein, or the processor 840 and the memory 830 may be otherwise configured to perform or support such operations.

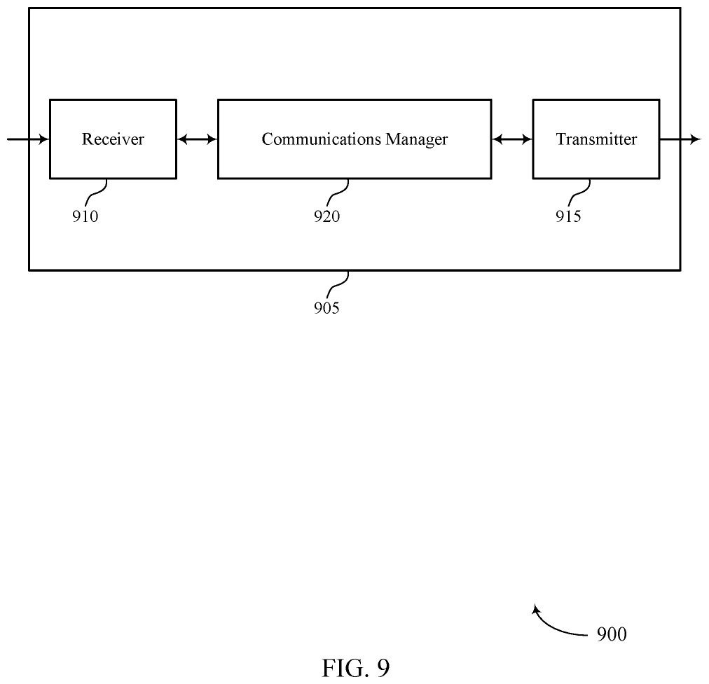

FIG. 9 shows a block diagram 900 of a device 905 that supports forward handover procedures for L2 relay mobility in accordance with aspects of the present disclosure. The device 905 may be an example of aspects of a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to forward handover procedures for L2 relay mobility). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to forward handover procedures for L2 relay mobility). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of forward handover procedures for L2 relay mobility as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a digital signal processor (DSP), an application-specific integrated circuit (ASIC), an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a relay UE in accordance with examples as disclosed herein. For example, the communications manager 920 may be configured as or otherwise support a means for receiving, from a UE, a message to establish a sidelink communication link with the UE, where the message includes an indication that the sidelink communication link is for a handover associated with a relay pairing between the UE and the relay UE. The communications manager 920 may be configured as or otherwise support a means for transmitting, to a base station, a connection setup request message based on establishing the sidelink communication link with the UE. The communications manager 920 may be configured as or otherwise support a means for receiving, from the base station in response to the connection setup request message, a connection setup complete message including an indication of a first signaling radio bearer associated with a relay link for the relay pairing.

Additionally or alternatively, the communications manager 920 may support wireless communications at a UE in accordance with examples as disclosed herein. For example, the communications manager 920 may be configured as or otherwise support a means for receiving, from a base station, a first message indicating a configuration of a relay UE, an identifier of the relay UE, and an indication for the UE to switch to a sidelink communications link with the relay UE, where the first message is based on a relay pairing between the UE and the relay UE. The communications manager 920 may be configured as or otherwise support a means for transmitting, to the relay UE, a second message to establish a sidelink communication link with the relay UE, where the second message includes an indication that the sidelink communication link is for a handover associated with the relay pairing. The communications manager 920 may be configured as or otherwise support a means for receiving, from the relay UE and in response to the second message, a third message configuring the sidelink communication link with the relay UE.

By including or configuring the communications manager 920 in accordance with examples as described herein, the device 905 (e.g., a processor controlling or otherwise coupled to the receiver 910, the transmitter 915, the communications manager 920, or a combination thereof) may support techniques for maintaining a continuity of service while performing a backward handover procedure.

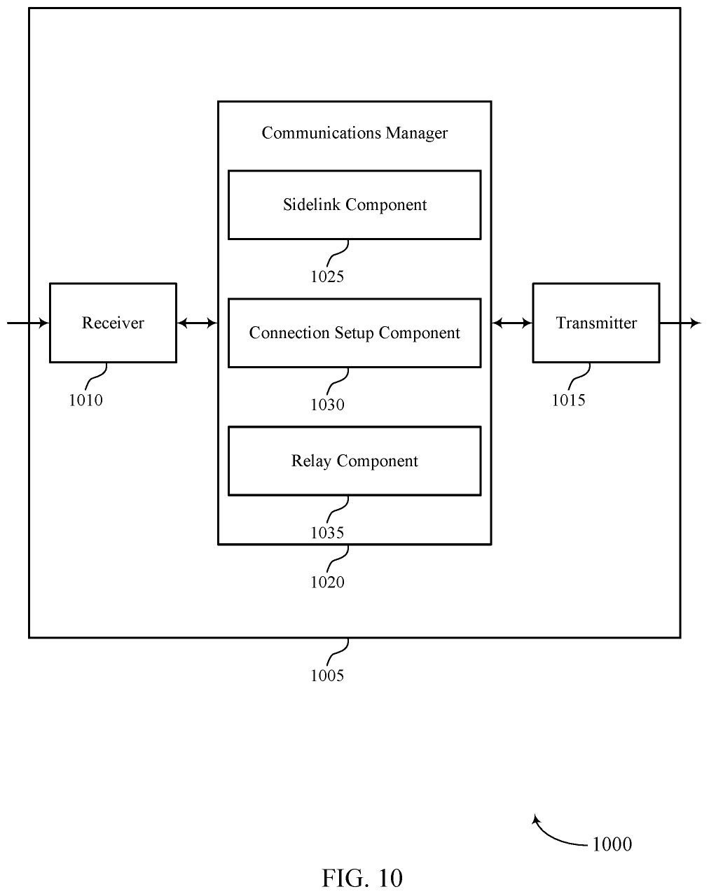

FIG. 10 shows a block diagram 1000 of a device 1005 that supports forward handover procedures for L2 relay mobility in accordance with aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to forward handover procedures for L2 relay mobility). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to forward handover procedures for L2 relay mobility). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of forward handover procedures for L2 relay mobility as described herein. For example, the communications manager 1020 may include a sidelink component 1025, a connection setup component 1030, a relay component 1035, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a relay UE in accordance with examples as disclosed herein. The sidelink component 1025 may be configured as or otherwise support a means for receiving, from a UE, a message to establish a sidelink communication link with the UE, where the message includes an indication that the sidelink communication link is for a handover associated with a relay pairing between the UE and the relay UE. The connection setup component 1030 may be configured as or otherwise support a means for transmitting, to a base station, a connection setup request message based on establishing the sidelink communication link with the UE. The connection setup component 1030 may be configured as or otherwise support a means for receiving, from the base station in response to the connection setup request message, a connection setup complete message including an indication of a first signaling radio bearer associated with a relay link for the relay pairing.

Additionally or alternatively, the communications manager 1020 may support wireless communications at a UE in accordance with examples as disclosed herein. The relay component 1035 may be configured as or otherwise support a means for receiving, from a base station, a first message indicating a configuration of a relay UE, an identifier of the relay UE, and an indication for the UE to switch to a sidelink communications link with the relay UE, where the first message is based on a relay pairing between the UE and the relay UE. The sidelink component 1025 may be configured as or otherwise support a means for transmitting, to the relay UE, a second message to establish a sidelink communication link with the relay UE, where the second message includes an indication that the sidelink communication link is for a handover associated with the relay pairing. The sidelink component 1025 may be configured as or otherwise support a means for receiving, from the relay UE and in response to the second message, a third message configuring the sidelink communication link with the relay UE.

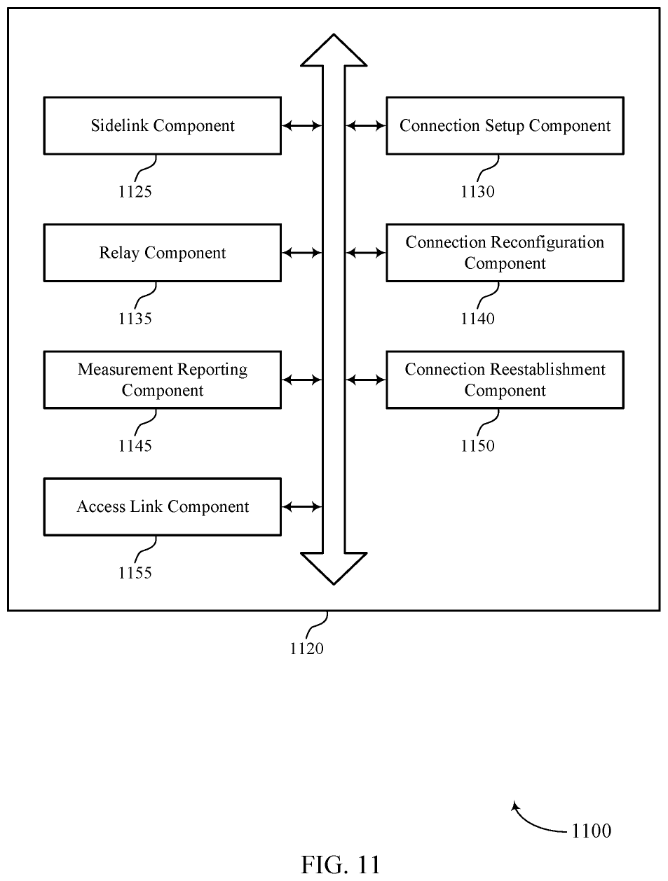

FIG. 11 shows a block diagram 1100 of a communications manager 1120 that supports forward handover procedures for L2 relay mobility in accordance with aspects of the present disclosure. The communications manager 1120 may be an example of aspects of a communications manager 920, a communications manager 1020, or both, as described herein. The communications manager 1120, or various components thereof, may be an example of means for performing various aspects of forward handover procedures for L2 relay mobility as described herein. For example, the communications manager 1120 may include a sidelink component 1125, a connection setup component 1130, a relay component 1135, a connection reconfiguration component 1140, a measurement reporting component 1145, a connection reestablishment component 1150, an access link component 1155, or any combination thereof. Each of these components may communicate, directly or indirectly, with one another (e.g., via one or more buses).

The communications manager 1120 may support wireless communication at a relay UE in accordance with examples as disclosed herein. The sidelink component 1125 may be configured as or otherwise support a means for receiving, from a UE, a message to establish a sidelink communication link with the UE, where the message includes an indication that the sidelink communication link is for a handover associated with a relay pairing between the UE and the relay UE. The connection setup component 1130 may be configured as or otherwise support a means for transmitting, to a base station, a connection setup request message based on establishing the sidelink communication link with the UE. In some examples, the connection setup component 1130 may be configured as or otherwise support a means for receiving, from the base station in response to the connection setup request message, a connection setup complete message including an indication of a first signaling radio bearer associated with a relay link for the relay pairing.

In some examples, the connection reconfiguration component 1140 may be configured as or otherwise support a means for transmitting a reconfiguration request message to the base station based on receiving the connection setup complete message. In some examples, the connection reconfiguration component 1140 may be configured as or otherwise support a means for receiving, from the base station, a reconfiguration complete message including an indication of a second signaling radio bearer for the relay link, or a data radio bearer for the relay link, or any combination thereof.

In some examples, the connection reestablishment component 1150 may be configured as or otherwise support a means for relaying, from the UE, a connection reestablishment request message to the base station based on the relay pairing between the UE and the relay UE. In some examples, the connection reestablishment component 1150 may be configured as or otherwise support a means for relaying, from the base station, a connection reestablishment message to the UE in response to the connection reestablishment request message.

In some examples, the connection reestablishment request message and the connection reestablishment message are relayed before receiving the reconfiguration complete message from the base station.

In some examples, a connection state of the relay UE includes an idle state or an inactive state.

Additionally or alternatively, the communications manager 1120 may support wireless communications at a UE in accordance with examples as disclosed herein. The relay component 1135 may be configured as or otherwise support a means for receiving, from a base station, a first message indicating a configuration of a relay UE, an identifier of the relay UE, and an indication for the UE to switch to a sidelink communications link with the relay UE, where the first message is based on a relay pairing between the UE and the relay UE. In some examples, the sidelink component 1125 may be configured as or otherwise support a means for transmitting, to the relay UE, a second message to establish a sidelink communication link with the relay UE, where the second message includes an indication that the sidelink communication link is for a handover associated with the relay pairing. In some examples, the sidelink component 1125 may be configured as or otherwise support a means for receiving, from the relay UE and in response to the second message, a third message configuring the sidelink communication link with the relay UE.

In some examples, the measurement reporting component 1145 may be configured as or otherwise support a means for transmitting a measurement report to the base station, where the measurement report includes an indication of a connection state of the relay UE, the identifier of the relay UE, a cell identifier of the relay UE, or any combination thereof, where the relay pairing is based on the measurement report.

In some examples, the connection reestablishment component 1150 may be configured as or otherwise support a means for transmitting, via the relay UE, a connection reestablishment request message to the base station based on the relay pairing between the UE and the relay UE. In some examples, the connection reestablishment component 1150 may be configured as or otherwise support a means for receiving, from the base station, a connection reestablishment message via the relay UE in response to the connection reestablishment request message.

In some examples, the access link component 1155 may be configured as or otherwise support a means for releasing an access link between the UE and a source base station based on receiving the connection reestablishment message via the relay UE, where the source base station is different from the base station.

In some examples, the access link component 1155 may be configured as or otherwise support a means for releasing an access link between the UE and a source base station based on receiving the first message, where the source base station is different from the base station.

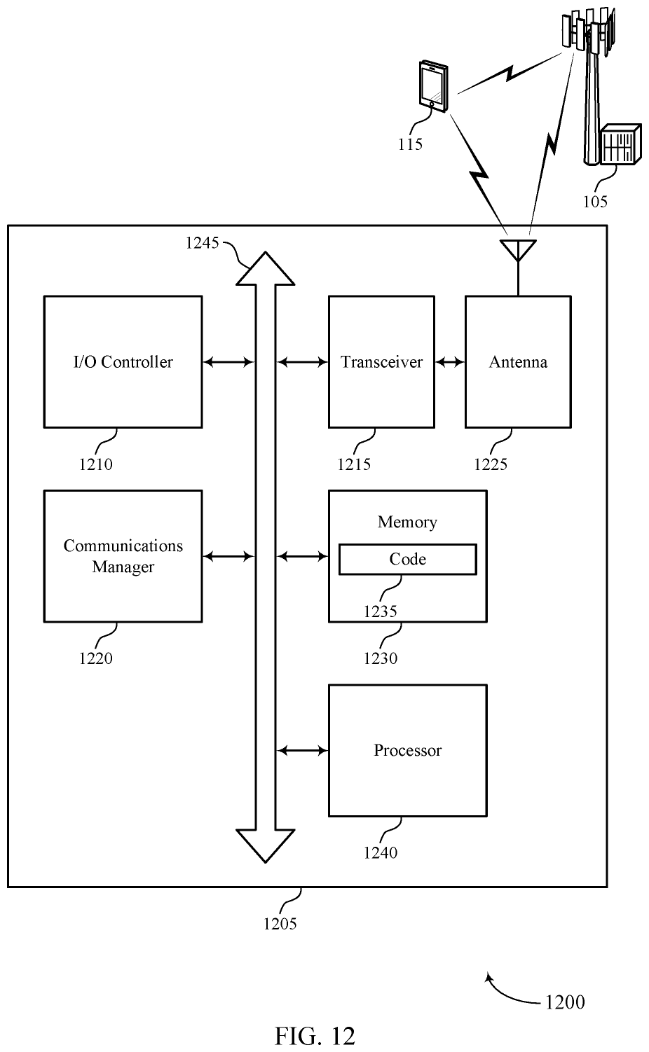

FIG. 12 shows a diagram of a system 1200 including a device 1205 that supports forward handover procedures for L2 relay mobility in accordance with aspects of the present disclosure. The device 1205 may be an example of or include the components of a device 905, a device 1005, or a UE 115 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting forward handover procedures for L2 relay mobility). For example, the device 1205 or a component of the device 1205 may include a processor 1240 and memory 1230 coupled to the processor 1240, the processor 1240 and memory 1230 configured to perform various functions described herein.

The communications manager 1220 may support wireless communication at a relay UE in accordance with examples as disclosed herein. For example, the communications manager 1220 may be configured as or otherwise support a means for receiving, from a UE, a message to establish a sidelink communication link with the UE, where the message includes an indication that the sidelink communication link is for a handover associated with a relay pairing between the UE and the relay UE. The communications manager 1220 may be configured as or otherwise support a means for transmitting, to a base station, a connection setup request message based on establishing the sidelink communication link with the UE. The communications manager 1220 may be configured as or otherwise support a means for receiving, from the base station in response to the connection setup request message, a connection setup complete message including an indication of a first signaling radio bearer associated with a relay link for the relay pairing.

Additionally or alternatively, the communications manager 1220 may support wireless communications at a UE in accordance with examples as disclosed herein. For example, the communications manager 1220 may be configured as or otherwise support a means for receiving, from a base station, a first message indicating a configuration of a relay UE, an identifier of the relay UE, and an indication for the UE to switch to a sidelink communications link with the relay UE, where the first message is based on a relay pairing between the UE and the relay UE. The communications manager 1220 may be configured as or otherwise support a means for transmitting, to the relay UE, a second message to establish a sidelink communication link with the relay UE, where the second message includes an indication that the sidelink communication link is for a handover associated with the relay pairing. The communications manager 1220 may be configured as or otherwise support a means for receiving, from the relay UE and in response to the second message, a third message configuring the sidelink communication link with the relay UE.

By including or configuring the communications manager 1220 in accordance with examples as described herein, the device 1205 may support techniques for improved coordination between devices.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of forward handover procedures for L2 relay mobility as described herein, or the processor 1240 and the memory 1230 may be otherwise configured to perform or support such operations.

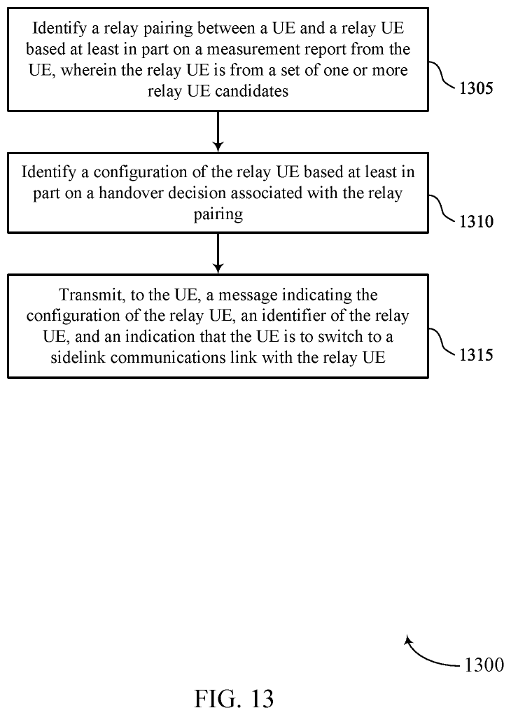

FIG. 13 shows a flowchart illustrating a method 1300 that supports forward handover procedures for L2 relay mobility in accordance with aspects of the present disclosure. The operations of the method 1300 may be implemented by a base station or its components as described herein. For example, the operations of the method 1300 may be performed by a base station 105 as described with reference to FIGS. 1 through 8. In some examples, a base station may execute a set of instructions to control the functional elements of the base station to perform the described functions. Additionally or alternatively, the base station may perform aspects of the described functions using special-purpose hardware.

At 1305, the method may include identifying a relay pairing between a UE and a relay UE based on a measurement report from the UE, where the relay UE is from a set of one or more relay UE candidates. The operations of 1305 may be performed in accordance with examples as disclosed herein. In some examples, aspects of the operations of 1305 may be performed by a relay manager 725 as described with reference to FIG. 7.

At 1310, the method may include identifying a configuration of the relay UE based on a handover decision associated with the relay pairing. The operations of 1310 may be performed in accordance with examples as disclosed herein. In some examples, aspects of the operations of 1310 may be performed by a handover manager 730 as described with reference to FIG. 7.

At 1315, the method may include transmitting, to the UE, a message indicating the configuration of the relay UE, an identifier of the relay UE, and an indication that the UE is to switch to a sidelink communications link with the relay UE. The operations of 1315 may be performed in accordance with examples as disclosed herein. In some examples, aspects of the operations of 1315 may be performed by a sidelink manager 735 as described with reference to FIG. 7.

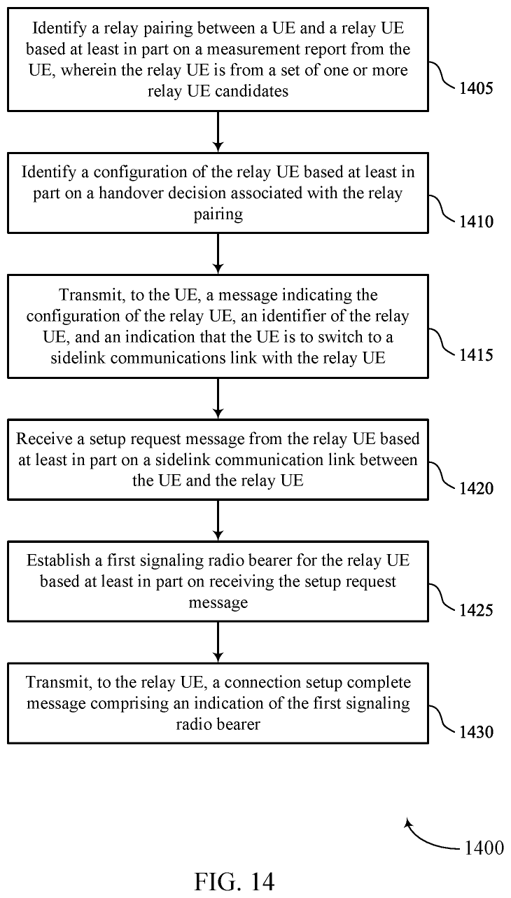

FIG. 14 shows a flowchart illustrating a method 1400 that supports forward handover procedures for L2 relay mobility in accordance with aspects of the present disclosure. The operations of the method 1400 may be implemented by a base station or its components as described herein. For example, the operations of the method 1400 may be performed by a base station 105 as described with reference to FIGS. 1 through 8. In some examples, a base station may execute a set of instructions to control the functional elements of the base station to perform the described functions. Additionally or alternatively, the base station may perform aspects of the described functions using special-purpose hardware.

At 1405, the method may include identifying a relay pairing between a UE and a relay UE based on a measurement report from the UE, where the relay UE is from a set of one or more relay UE candidates. The operations of 1405 may be performed in accordance with examples as disclosed herein. In some examples, aspects of the operations of 1405 may be performed by a relay manager 725 as described with reference to FIG. 7.

At 1410, the method may include identifying a configuration of the relay UE based on a handover decision associated with the relay pairing. The operations of 1410 may be performed in accordance with examples as disclosed herein. In some examples, aspects of the operations of 1410 may be performed by a handover manager 730 as described with reference to FIG. 7.

At 1415, the method may include transmitting, to the UE, a message indicating the configuration of the relay UE, an identifier of the relay UE, and an indication that the UE is to switch to a sidelink communications link with the relay UE. The operations of 1415 may be performed in accordance with examples as disclosed herein. In some examples, aspects of the operations of 1415 may be performed by a sidelink manager 735 as described with reference to FIG. 7.

At 1420, the method may include receiving a setup request message from the relay UE based on a sidelink communication link between the UE and the relay UE. The operations of 1420 may be performed in accordance with examples as disclosed herein. In some examples, aspects of the operations of 1420 may be performed by a connection manager 740 as described with reference to FIG. 7.

At 1425, the method may include establishing a first signaling radio bearer for the relay UE based on receiving the setup request message. The operations of 1425 may be performed in accordance with examples as disclosed herein. In some examples, aspects of the operations of 1425 may be performed by a bearer manager 745 as described with reference to FIG. 7.

At 1430, the method may include transmitting, to the relay UE, a connection setup complete message including an indication of the first signaling radio bearer. The operations of 1430 may be performed in accordance with examples as disclosed herein. In some examples, aspects of the operations of 1430 may be performed by a connection manager 740 as described with reference to FIG. 7.

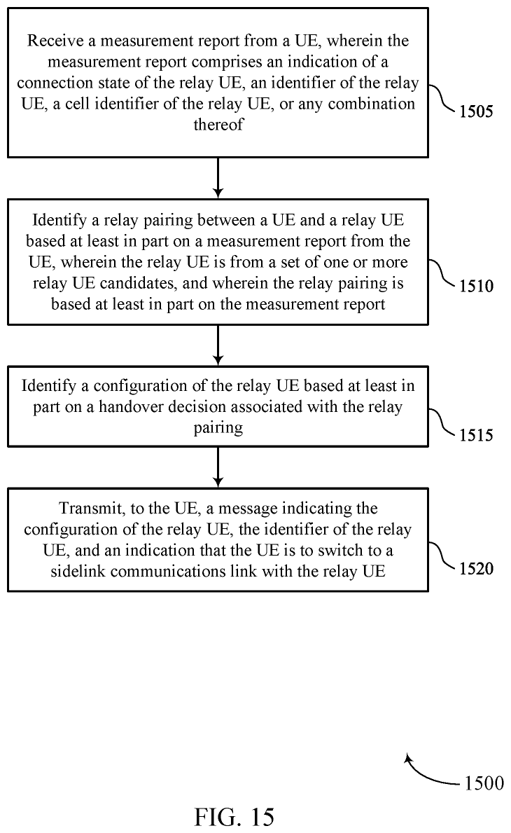

FIG. 15 shows a flowchart illustrating a method 1500 that supports forward handover procedures for L2 relay mobility in accordance with aspects of the present disclosure. The operations of the method 1500 may be implemented by a base station or its components as described herein. For example, the operations of the method 1500 may be performed by a base station 105 as described with reference to FIGS. 1 through 8. In some examples, a base station may execute a set of instructions to control the functional elements of the base station to perform the described functions. Additionally or alternatively, the base station may perform aspects of the described functions using special-purpose hardware.

At 1505, the method may include receiving a measurement report from a UE, where the measurement report includes an indication of a connection state of the relay UE, an identifier of the relay UE, a cell identifier of the relay UE, or any combination thereof. The operations of 1505 may be performed in accordance with examples as disclosed herein. In some examples, aspects of the operations of 1505 may be performed by a measurement manager 750 as described with reference to FIG. 7.

At 1510, the method may include identifying a relay pairing between a UE and a relay UE based on a measurement report from the UE, where the relay UE is from a set of one or more relay UE candidates, and where the relay pairing is based on the measurement report. The operations of 1510 may be performed in accordance with examples as disclosed herein. In some examples, aspects of the operations of 1510 may be performed by a relay manager 725 as described with reference to FIG. 7.

At 1515, the method may include identifying a configuration of the relay UE based on a handover decision associated with the relay pairing. The operations of 1515 may be performed in accordance with examples as disclosed herein. In some examples, aspects of the operations of 1515 may be performed by a handover manager 730 as described with reference to FIG. 7.

At 1520, the method may include transmitting, to the UE, a message indicating the configuration of the relay UE, the identifier of the relay UE, and an indication that the UE is to switch to a sidelink communications link with the relay UE. The operations of 1520 may be performed in accordance with examples as disclosed herein. In some examples, aspects of the operations of 1520 may be performed by a sidelink manager 735 as described with reference to FIG. 7.

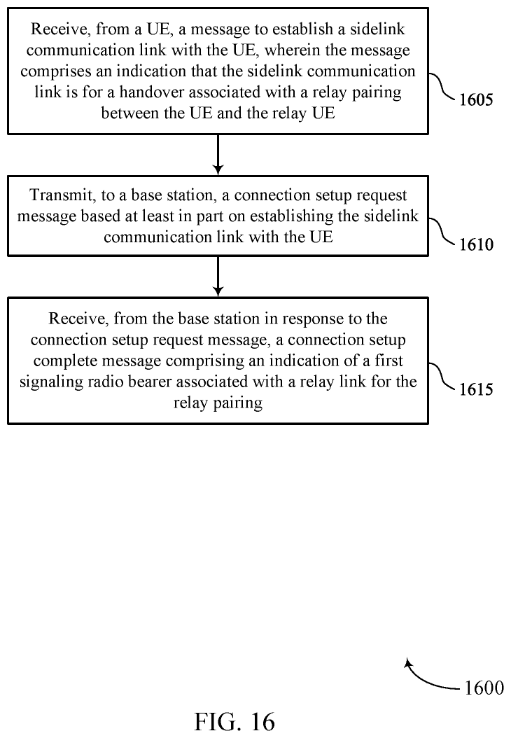

FIG. 16 shows a flowchart illustrating a method 1600 that supports forward handover procedures for L2 relay mobility in accordance with aspects of the present disclosure. The operations of the method 1600 may be implemented by a UE or its components as described herein. For example, the operations of the method 1600 may be performed by a UE 115 as described with reference to FIGS. 1 through 4 and 9 through 12. In some examples, a UE may execute a set of instructions to control the functional elements of the UE to perform the described functions. Additionally or alternatively, the UE may perform aspects of the described functions using special-purpose hardware.

At 1605, the method may include receiving, from a UE, a message to establish a sidelink communication link with the UE, where the message includes an indication that the sidelink communication link is for a handover associated with a relay pairing between the UE and the relay UE. The operations of 1605 may be performed in accordance with examples as disclosed herein. In some examples, aspects of the operations of 1605 may be performed by a sidelink component 1125 as described with reference to FIG. 11.

At 1610, the method may include transmitting, to a base station, a connection setup request message based on establishing the sidelink communication link with the UE. The operations of 1610 may be performed in accordance with examples as disclosed herein. In some examples, aspects of the operations of 1610 may be performed by a connection setup component 1130 as described with reference to FIG. 11.

At 1615, the method may include receiving, from the base station in response to the connection setup request message, a connection setup complete message including an indication of a first signaling radio bearer associated with a relay link for the relay pairing. The operations of 1615 may be performed in accordance with examples as disclosed herein. In some examples, aspects of the operations of 1615 may be performed by a connection setup component 1130 as described with reference to FIG. 11.

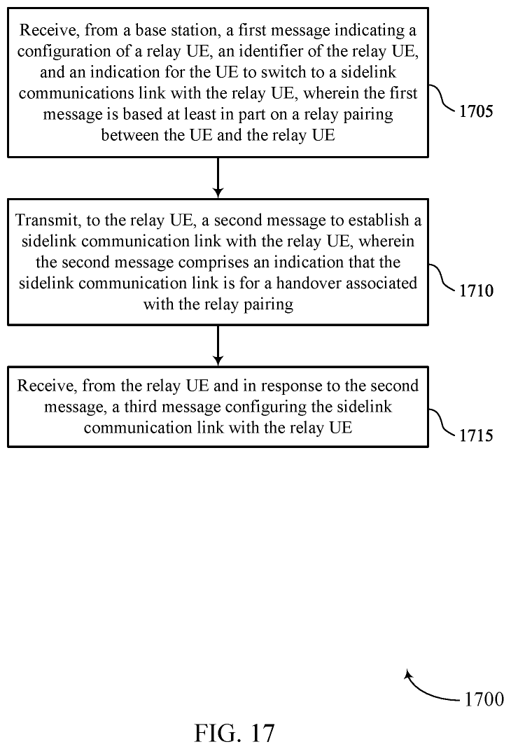

FIG. 17 shows a flowchart illustrating a method 1700 that supports forward handover procedures for L2 relay mobility in accordance with aspects of the present disclosure. The operations of the method 1700 may be implemented by a UE or its components as described herein. For example, the operations of the method 1700 may be performed by a UE 115 as described with reference to FIGS. 1 through 4 and 9 through 12. In some examples, a UE may execute a set of instructions to control the functional elements of the UE to perform the described functions. Additionally or alternatively, the UE may perform aspects of the described functions using special-purpose hardware.

At 1705, the method may include receiving, from a base station, a first message indicating a configuration of a relay UE, an identifier of the relay UE, and an indication for the UE to switch to a sidelink communications link with the relay UE, where the first message is based on a relay pairing between the UE and the relay UE. The operations of 1705 may be performed in accordance with examples as disclosed herein. In some examples, aspects of the operations of 1705 may be performed by a relay component 1135 as described with reference to FIG. 11.

At 1710, the method may include transmitting, to the relay UE, a second message to establish a sidelink communication link with the relay UE, where the second message includes an indication that the sidelink communication link is for a handover associated with the relay pairing. The operations of 1710 may be performed in accordance with examples as disclosed herein. In some examples, aspects of the operations of 1710 may be performed by a sidelink component 1125 as described with reference to FIG. 11.

At 1715, the method may include receiving, from the relay UE and in response to the second message, a third message configuring the sidelink communication link with the relay UE. The operations of 1715 may be performed in accordance with examples as disclosed herein. In some examples, aspects of the operations of 1715 may be performed by a sidelink component 1125 as described with reference to FIG. 11.

The following provides an overview of aspects of the present disclosure:
Aspect 1: A method for wireless communication at a base station, comprising: identifying a relay pairing between a UE and a relay UE based at least in part on a measurement report from the UE, wherein the relay UE is from a set of one or more relay UE candidates; identifying a configuration of the relay UE based at least in part on a handover decision associated with the relay pairing; and transmitting, to the UE, a message indicating the configuration of the relay UE, an identifier of the relay UE, and an indication that the UE is to switch to a sidelink communications link with the relay UE.
Aspect 2: The method of aspect 1, further comprising: receiving a setup request message from the relay UE based at least in part on a sidelink communication link between the UE and the relay UE; establishing a first signaling radio bearer for the relay UE based at least in part on receiving the setup request message; and transmitting, to the relay UE, a connection setup complete message comprising an indication of the first signaling radio bearer.
Aspect 3: The method of aspect 2, further comprising: establishing a second signaling radio bearer, or a data radio bearer, or any combination thereof, based at least in part on the configuration of the relay UE; and transmitting, to the relay UE, a reconfiguration complete message comprising an indication of the second signaling radio bearer, or the data radio bearer, or any combination thereof.
Aspect 4: The method of aspect 3, further comprising: receiving, via the relay UE, a connection reestablishment request message from the UE based at least in part on the relay pairing between the UE and the relay UE; identifying context information associated with the relay UE; and transmitting, to the UE, a connection reestablishment message via the relay UE in response to the connection reestablishment request message, wherein transmitting the connection reestablishment message is based at least in part on identifying the context information associated with the relay UE.
Aspect 5: The method of aspect 4, wherein the first signaling radio bearer, the second signaling radio bearer, the data radio bearer, or any combination thereof, is established after receiving the connection reestablishment request message from the UE.
Aspect 6: The method of any of aspects 4 through 5, wherein identifying the context information associated with the relay UE comprises: transmitting, to an anchor base station associated with the relay UE, a request for the context information associated with the relay UE, wherein the request for the context information is based at least in part on receiving the connection reestablishment request message from the UE; and receiving, from the anchor base station, the context information for the relay UE based at least in part on the request for the context information.
Aspect 7: The method of any of aspects 1 through 6, further comprising: receiving the measurement report from the UE, wherein the measurement report comprises an indication of a connection state of the relay UE, the identifier of the relay UE, a cell identifier of the relay UE, or any combination thereof, wherein the relay pairing is based at least in part on the measurement report.
Aspect 8: The method of any of aspects 1 through 7, further comprising: generating a handover command for the UE based at least in part on the handover decision.
Aspect 9: The method of any of aspects 1 through 8, further comprising: storing a L2 identifier of the UE and a L2 identifier of the relay UE based at least in part on the relay pairing; and releasing an access link with the UE based at least in part on storing the L2 identifier of the UE and the L2 identifier or the relay UE.
Aspect 10: The method of any of aspects 1 through 9, wherein the message comprises an RRC reconfiguration message.
Aspect 11: The method of any of aspects 1 through 10, wherein a connection state of the relay UE comprises an idle state or an inactive state.
Aspect 12: A method for wireless communication at a relay UE, comprising: receiving, from a UE, a message to establish a sidelink communication link with the UE, wherein the message comprises an indication that the sidelink communication link is for a handover associated with a relay pairing between the UE and the relay UE; transmitting, to a base station, a connection setup request message based at least in part on establishing the sidelink communication link with the UE; and receiving, from the base station in response to the connection setup request message, a connection setup complete message comprising an indication of a first signaling radio bearer associated with a relay link for the relay pairing.
Aspect 13: The method of aspect 12, further comprising: transmitting a reconfiguration request message to the base station based at least in part on receiving the connection setup complete message; and receiving, from the base station, a reconfiguration complete message comprising an indication of a second signaling radio bearer for the relay link, or a data radio bearer for the relay link, or any combination thereof.
Aspect 14: The method of aspect 13, further comprising: relaying, from the UE, a connection reestablishment request message to the base station based at least in part on the relay pairing between the UE and the relay UE; and relaying, from the base station, a connection reestablishment message to the UE in response to the connection reestablishment request message.
Aspect 15: The method of aspect 14, wherein the connection reestablishment request message and the connection reestablishment message are relayed before receiving the reconfiguration complete message from the base station.
Aspect 16: The method of any of aspects 12 through 15, wherein a connection state of the relay UE comprises an idle state or an inactive state.
Aspect 17: A method for wireless communications at a UE, comprising: receiving, from a base station, a first message indicating a configuration of a relay UE, an identifier of the relay UE, and an indication for the UE to switch to a sidelink communications link with the relay UE, wherein the first message is based at least in part on a relay pairing between the UE and the relay UE; transmitting, to the relay UE, a second message to establish a sidelink communication link with the relay UE, wherein the second message comprises an indication that the sidelink communication link is for a handover associated with the relay pairing; and receiving, from the relay UE and in response to the second message, a third message configuring the sidelink communication link with the relay UE.
Aspect 18: The method of aspect 17, further comprising: transmitting a measurement report to the base station, wherein the measurement report comprises an indication of a connection state of the relay UE, the identifier of the relay UE, a cell identifier of the relay UE, or any combination thereof, wherein the relay pairing is based at least in part on the measurement report.
Aspect 19: The method of any of aspects 17 through 18, further comprising: transmitting, via the relay UE, a connection reestablishment request message to the base station based at least in part on the relay pairing between the UE and the relay UE; and receiving, from the base station, a connection reestablishment message via the relay UE in response to the connection reestablishment request message.
Aspect 20: The method of aspect 19, further comprising: releasing an access link between the UE and a source base station based at least in part on receiving the connection reestablishment message via the relay UE, wherein the source base station is different from the base station.
Aspect 21: The method of any of aspects 17 through 20, further comprising: releasing an access link between the UE and a source base station based at least in part on receiving the first message, wherein the source base station is different from the base station.
Aspect 22: An apparatus for wireless communication at a base station, comprising a processor; memory coupled with the processor; and instructions stored in the memory and executable by the processor to cause the apparatus to perform a method of any of aspects 1 through 11.
Aspect 23: An apparatus for wireless communication at a base station, comprising at least one means for performing a method of any of aspects 1 through 11.
Aspect 24: A non-transitory computer-readable medium storing code for wireless communication at a base station, the code comprising instructions executable by a processor to perform a method of any of aspects 1 through 11.
Aspect 25: An apparatus for wireless communication at a relay UE, comprising a processor; memory coupled with the processor; and instructions stored in the memory and executable by the processor to cause the apparatus to perform a method of any of aspects 12 through 16.
Aspect 26: An apparatus for wireless communication at a relay UE, comprising at least one means for performing a method of any of aspects 12 through 16.
Aspect 27: A non-transitory computer-readable medium storing code for wireless communication at a relay UE, the code comprising instructions executable by a processor to perform a method of any of aspects 12 through 16.
Aspect 28: An apparatus for wireless communications at a UE, comprising a processor; memory coupled with the processor; and instructions stored in the memory and executable by the processor to cause the apparatus to perform a method of any of aspects 17 through 21.
Aspect 29: An apparatus for wireless communications at a UE, comprising at least one means for performing a method of any of aspects 17 through 21.
Aspect 30: A non-transitory computer-readable medium storing code for wireless communications at a UE, the code comprising instructions executable by a processor to perform a method of any of aspects 17 through 21.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communication at a base station, comprising:
identifying a relay pairing between a user equipment (UE) and a relay UE based at least in part on a measurement report from the UE, wherein the relay UE is from a set of one or more relay UE candidates;
identifying a configuration of the relay UE based at least in part on a handover decision associated with the relay pairing; and
transmitting, to the UE, a message indicating the configuration of the relay UE, an identifier of the relay UE, and an indication that the UE is to switch to a sidelink communications link with the relay UE.

2. The method of claim 1, further comprising:
receiving a setup request message from the relay UE based at least in part on a sidelink communication link between the UE and the relay UE;
establishing a first signaling radio bearer for the relay UE based at least in part on receiving the setup request message; and
transmitting, to the relay UE, a connection setup complete message comprising an indication of the first signaling radio bearer.

3. The method of claim 2, further comprising:
establishing a second signaling radio bearer, or a data radio bearer, or any combination thereof, based at least in part on the configuration of the relay UE; and
transmitting, to the relay UE, a reconfiguration complete message comprising an indication of the second signaling radio bearer, or the data radio bearer, or any combination thereof.

4. The method of claim 3, further comprising:
receiving, via the relay UE, a connection reestablishment request message from the UE based at least in part on the relay pairing between the UE and the relay UE;
identifying context information associated with the relay UE; and
transmitting, to the UE, a connection reestablishment message via the relay UE in response to the connection reestablishment request message, wherein transmitting the connection reestablishment message is based at least in part on identifying the context information associated with the relay UE.

5. The method of claim 4, wherein the first signaling radio bearer, the second signaling radio bearer, the data radio bearer, or any combination thereof, is established after receiving the connection reestablishment request message from the UE.

6. The method of claim 4, wherein identifying the context information associated with the relay UE comprises:
transmitting, to an anchor base station associated with the relay UE, a request for the context information associated with the relay UE, wherein the request for the context information is based at least in part on receiving the connection reestablishment request message from the UE; and
receiving, from the anchor base station, the context information for the relay UE based at least in part on the request for the context information.

7. The method of claim 1, further comprising:
receiving the measurement report from the UE, wherein the measurement report comprises an indication of a connection state of the relay UE, the identifier of the relay UE, a cell identifier of the relay UE, or any combination thereof, wherein the relay pairing is based at least in part on the measurement report.

8. The method of claim 1, further comprising:
generating a handover command for the UE based at least in part on the handover decision.

9. The method of claim 1, further comprising:
storing a layer 2 identifier of the UE and a layer 2 identifier of the relay UE based at least in part on the relay pairing; and
releasing an access link with the UE based at least in part on storing the layer 2 identifier of the UE and the layer 2 identifier or the relay UE.

10. The method of claim 1, wherein the message comprises a radio resource control reconfiguration message.

11. The method of claim 1, wherein a connection state of the relay UE comprises an idle state or an inactive state.

12. A method for wireless communication at a relay user equipment (UE), comprising:
receiving, from a UE, a message to establish a sidelink communication link with the UE, wherein the message comprises an indication that the sidelink communication link is for a handover associated with a relay pairing between the UE and the relay UE;
transmitting, to a base station, a connection setup request message based at least in part on establishing the sidelink communication link with the UE; and
receiving, from the base station in response to the connection setup request message, a connection setup complete message comprising an indication of a first signaling radio bearer associated with a relay link for the relay pairing.

13. The method of claim 12, further comprising:
transmitting a reconfiguration request message to the base station based at least in part on receiving the connection setup complete message; and
receiving, from the base station, a reconfiguration complete message comprising an indication of a second signaling radio bearer for the relay link, or a data radio bearer for the relay link, or any combination thereof.

14. The method of claim 13, further comprising:
relaying, from the UE, a connection reestablishment request message to the base station based at least in part on the relay pairing between the UE and the relay UE; and
relaying, from the base station, a connection reestablishment message to the UE in response to the connection reestablishment request message.

15. The method of claim 14, wherein the connection reestablishment request message and the connection reestablishment message are relayed before receiving the reconfiguration complete message from the base station.

16. The method of claim 12, wherein a connection state of the relay UE comprises an idle state or an inactive state.

17. A method for wireless communications at a user equipment (UE), comprising:
receiving, from a base station, a first message indicating a configuration of a relay UE, an identifier of the relay UE, and an indication for the UE to switch to a sidelink communications link with the relay UE, wherein the first message is based at least in part on a relay pairing between the UE and the relay UE;
transmitting, to the relay UE, a second message to establish a sidelink communication link with the relay UE, wherein the second message comprises an indication that the sidelink communication link is for a handover associated with the relay pairing; and
receiving, from the relay UE and in response to the second message, a third message configuring the sidelink communication link with the relay UE.

18. The method of claim 17, further comprising:
transmitting a measurement report to the base station, wherein the measurement report comprises an indication of a connection state of the relay UE, the identifier of the relay UE, a cell identifier of the relay UE, or any combination thereof, wherein the relay pairing is based at least in part on the measurement report.

19. The method of claim 17, further comprising:
transmitting, via the relay UE, a connection reestablishment request message to the base station based at least in part on the relay pairing between the UE and the relay UE; and
receiving, from the base station, a connection reestablishment message via the relay UE in response to the connection reestablishment request message.

20. The method of claim 19, further comprising:
releasing an access link between the UE and a source base station based at least in part on receiving the connection reestablishment message via the relay UE, wherein the source base station is different from the base station.

21. The method of claim 17, further comprising:
releasing an access link between the UE and a source base station based at least in part on receiving the first message, wherein the source base station is different from the base station.

22-53. (canceled)

54. An apparatus for wireless communication at a relay user equipment (UE), comprising:
a processor;
memory coupled with the processor; and
instructions stored in the memory and executable by the processor to cause the apparatus to:
receive, from a UE, a message to establish a sidelink communication link with the UE, wherein the message comprises an indication that the sidelink communication link is for a handover associated with a relay pairing between the UE and the relay UE;
transmit, to a base station, a connection setup request message based at least in part on establishing the sidelink communication link with the UE; and
receive, from the base station in response to the connection setup request message, a connection setup complete message comprising an indication of a first signaling radio bearer associated with a relay link for the relay pairing.

55. The apparatus of claim 54, wherein the instructions are further executable by the processor to cause the apparatus to:
transmit a reconfiguration request message to the base station based at least in part on receiving the connection setup complete message; and
receive, from the base station, a reconfiguration complete message comprising an indication of a second signaling radio bearer for the relay link, or a data radio bearer for the relay link, or any combination thereof.

56. The apparatus of claim 55, wherein the instructions are further executable by the processor to cause the apparatus to:
relay, from the UE, a connection reestablishment request message to the base station based at least in part on the relay pairing between the UE and the relay UE; and
relay, from the base station, a connection reestablishment message to the UE in response to the connection reestablishment request message.

57. The apparatus of claim 56, wherein the connection reestablishment request message and the connection reestablishment message are relayed before receiving the reconfiguration complete message from the base station.

58. The apparatus of claim 54, wherein a connection state of the relay UE comprises an idle state or an inactive state.

59. An apparatus for wireless communications at a user equipment (UE), comprising:
a processor;
memory coupled with the processor; and
instructions stored in the memory and executable by the processor to cause the apparatus to:
receive, from a base station, a first message indicating a configuration of a relay UE, an identifier of the relay UE, and an indication for the UE to switch to a sidelink communications link with the relay UE, wherein the first message is based at least in part on a relay pairing between the UE and the relay UE;
transmit, to the relay UE, a second message to establish a sidelink communication link with the relay UE, wherein the second message comprises an indication that the sidelink communication link is for a handover associated with the relay pairing; and
receive, from the relay UE and in response to the second message, a third message configuring the sidelink communication link with the relay UE.

60. The apparatus of claim 59, wherein the instructions are further executable by the processor to cause the apparatus to:
transmit a measurement report to the base station, wherein the measurement report comprises an indication of a connection state of the relay UE, the identifier of the relay UE, a cell identifier of the relay UE, or any combination thereof, wherein the relay pairing is based at least in part on the measurement report.

61. The apparatus of claim 59, wherein the instructions are further executable by the processor to cause the apparatus to:
transmit, via the relay UE, a connection reestablishment request message to the base station based at least in part on the relay pairing between the UE and the relay UE; and
receive, from the base station, a connection reestablishment message via the relay UE in response to the connection reestablishment request message.

62. The apparatus of claim 61, wherein the instructions are further executable by the processor to cause the apparatus to:
release an access link between the UE and a source base station based at least in part on receiving the connection reestablishment message via the relay UE, wherein the source base station is different from the base station.

63. The apparatus of claim 59, wherein the instructions are further executable by the processor to cause the apparatus to:
release an access link between the UE and a source base station based at least in part on receiving the first message, wherein the source base station is different from the base station.

64-87. (canceled)
